(19) United States
(12) Patent Application Publication
(10) Pub. No.: US 2010/0313171 A1
(43) Pub. Date: Dec. 9, 2010

(54) Information Display System and Information Display Apparatus

(75) Inventors: Tsutomu YANAGI, Daito-shi (JP); Shusuke Narita, Daito-shi (JP); Tetsuya Shihara, Daito-shi (JP); Kazuteru Adachi, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 12/794,864

(22) Filed: Jun. 7, 2010

(30) Foreign Application Priority Data
Jun. 5, 2009 (JP) 2009-135877

(51) Int. Cl. G06F 3/048; H04N 7/173

(52) U.S. Cl. 715/856; 725/131

(57) ABSTRACT

This information display system includes an input device, a computer, a receiving apparatus including a receiving portion and a control portion and a display portion, and a user can set whether to transmit operating information from the computer to the receiving apparatus in at least either the computer or the receiving apparatus in the information display system.

### BACKGROUND OF THE INVENTION

1. Field of the Invention

The present invention relates to an information display system and an information display apparatus, and more particularly, it relates to an information display system comprising an input device to which a user inputs operating information and an information display apparatus.

2. Description of the Background Art

An information display system comprising an input device to which a user inputs operating information and an information display apparatus are known in general, as disclosed in each of Japanese Patent Laying-Open No. 2002-344835 and Japanese Patent Laying-Open No. 8-87784 (1996), for example.

The aforementioned Japanese Patent Laying-Open No. 2002-344835 discloses a system constituted by a mouse (input device) to which an operation by a user is input, a PC (Personal Computer) and a display (receiving device) connected with the mouse and the PC and comprising a TV tuner. The display described in the aforementioned Japanese Patent Laying-Open No. 2002-344835 is connected to the PC through a USB (Universal Serial Bus) line. The display transmits a video signal regarding a TV broadcast received from the TV tuner to the PC through the USB line when the PC is on. Further, the display transmits an operation signal input from the mouse to the PC through the USB line, selecting the PC as an operation object of the mouse. The PC transmits an instruction based on the operation signal from the mouse to the display through the UBS line when the operation signal from the mouse is a signal regarding an operation to the display. On the other hand, the display controls itself on the basis of the operation signal input from the mouse, selecting the display itself as an operation object of the mouse when the PC is off not on.

The aforementioned Japanese Patent Laying-Open No. 8-87784 discloses a television program recording reservation apparatus comprising a mouse (input device) transmitting movement data, a television receiver body (receiver) and a PC (Personal Computer) connected with the mouse and the television receiver body. The PC of the television program recording reservation apparatus described in the aforementioned Japanese Patent Laying-Open No. 8-87784 prepares information regarding a screen so formed as to superimpose and display a cursor on an acquired program list and prepares information organized to move a display position of the cursor on the basis of the movement data transmitted from the mouse to transmit both of the information to the television receiver body. Thus, the PC is so formed as to allow the television receiver body to display the screen where the cursor whose display position is moved is superimposed and displayed on the program list.

The system described in the aforementioned Japanese Patent Laying-Open No. 2002-344835, however, is so formed as to transmit the instruction based on the operation signal of the mouse to the display from the PC after once transmitting the operation signal of the mouse from the display connected with the mouse to the PC, when the PC is on and the operation signal input from the mouse is a signal regarding the operation to the display. Therefore, in the system described in the aforementioned Japanese Patent Laying-Open No. 2002-344835, the display must disadvantageously once transmit the operation signal of the mouse to the PC and the PC must disadvantageously again transmit the received instruction based on the operation signal of the mouse, through the USB line although the display can control itself on the basis of the operation signal from of the mouse. Thus, it is conceivable that unnecessary processing in the PC is increased so that a load applied to the PC is disadvantageously increased.

In the television program recording reservation apparatus described in the aforementioned Japanese Patent Laying-Open No. 8-87784, the PC is so formed as to move the display position of the curser on the basis of movement data transmitted from the mouse, and hence the movement data of the mouse is not disadvantageously processed in the television receiver body. When performing operations in the television receiver body with the mouse, therefore, programs of control actions regarding the operations in the television receiver body must be stored in the PC. Further, the PC must perform processing based on movement data of the mouse or the like on the basis of the programs of control actions regarding the operations in the television receiver body. Consequently, it is conceivable that processing in the PC is increased so that a load applied to the PC is disadvantageously increased.

### SUMMARY OF THE INVENTION

The present invention has been proposed in order to solve the aforementioned problems, and an object of the present invention is to provide an information display system and an information display apparatus capable of inhibiting a load applied to a computer from increase. An information display system according to a first aspect of the present invention comprises an input device to which a user inputs operating information, a computer connected with the input device, including a transmitting portion for transmitting the operating information input through the input device, a receiving apparatus including a receiving portion for receiving the operating information transmitted by the computer and a control portion capable of performing display processing of a cursor on the basis of the operating information of the input device, and a display portion provided on a side of the receiving apparatus, capable of displaying an image and displaying an image on which the display processing for composing the cursor with an image is performed by the control portion of the receiving apparatus on the basis of the operating information of the input device, wherein the user can set whether to transmit the operating information from the computer to the receiving apparatus in at least either the computer or the receiving apparatus.

In the information display system according to the first aspect of the present invention, as hereinabove described, the receiving apparatus includes the control portion capable of performing the display processing of the cursor on the basis of the operating information of the input device. Thus, processing to the receiving apparatus regarding an operation based on the operating information of the input device can be performed in the control portion of the receiving apparatus so that the processing to the receiving apparatus regarding an operation based on the operating information of the input device may not be performed in the computer. As a result, processing in the computer can be inhibited from increase so that a load applied to the computer can be inhibited from increase.

Further, as hereinabove described, the user can set whether to transmit the operating information from the computer to the receiving apparatus in at least either the computer or the receiving apparatus, whereby the user can set the operating information not to be transmitted from the computer to the receiving apparatus when the operating information from the computer to the receiving apparatus is not necessary. Thus, the unnecessary operating information can be inhibited from being transmitted to the receiving apparatus so that a load applied to the receiving apparatus can be inhibited from increase.

In the aforementioned information display system according to the first aspect, the input device preferably includes a pointing device, the operating information preferably includes information regarding a position of the pointing device, and the control portion of the receiving apparatus is preferably formed to compose the cursor with an image on the basis of the information regarding a position of the pointing device. According to this structure, the control portion of the receiving apparatus can compose the cursor with an image on the basis of the information regarding a position of the pointing device that the user can intuitively operate as compared with an input device such as a keyboard and a remote controller. Thus, operability for the user in operating the receiving apparatus can be improved.

In this case, the information display system preferably further comprises a conversion portion for converting the information regarding a position of the pointing device so that the cursor can be composed with an image when a screen resolution set in the computer and a screen resolution set in the receiving apparatus are different from each other. According to this structure, the control portion of the receiving apparatus can perform display processing for composing the cursor with an image and allow display of the display-processed image on the basis of the converted information regarding a position of the pointing device also when the screen resolution set in the computer and the screen resolution set in the receiving apparatus are different from each other.

In the aforementioned information display system further comprising the conversion portion, the conversion portion preferably converts the information regarding a position of the pointing device on the basis of a ratio of the screen resolution set in the receiving apparatus to the screen resolution set in the computer. According to this structure, the information regarding a position of the pointing device can be easily converted on the basis of the ratio of the screen resolution set in the receiving apparatus to the screen resolution set in the computer.

In the aforementioned information display system according to the first aspect, the receiving apparatus preferably further includes a first memory portion storing a program for transmitting the operating information input to the computer through the input device and a program transmitting portion transmitting the program to the computer, the computer preferably further includes a program receiving portion receiving the program from the receiving apparatus and a second memory portion storing the received program, the receiving apparatus preferably transmits the program to the computer when the receiving apparatus and the computer are connected to each other so that the program is stored in the second memory portion of the computer, and the computer preferably transmits the operating information input through the input device on the basis of the program stored in the second memory portion. According to this structure, the computer can obtain the program for transmitting the operating information input through the input device only by connecting the receiving apparatus and the computer with each other. Thus, the user may not separately perform an operation for obtaining the program for transmitting the operating information input through the input device so that convenience for the user can be improved.

In this case, the user preferably sets whether to transmit the operating information from the computer to the receiving apparatus, and the computer preferably further transmits the operating information to the receiving apparatus when the user sets the computer to transmit the operating information on the basis of the program. According to this structure, the user can easily set whether to transmit the operating information and the computer can easily transmit the operating information to the receiving apparatus on the basis of the obtained program. Thus, convenience for the user can be improved.

In the aforementioned information display system according to the first aspect, the computer preferably transmits the operating information to the receiving apparatus without analyzing the operating information when the user sets the computer to transmit the operating information. According to this structure, the operating information is not analyzed in the computer when unnecessary in the computer so that a load applied to the computer can be inhibited from increase.

In the aforementioned information display system according to the first aspect, the computer preferably further includes an image transmitting portion for transmitting an image of the computer to the receiving apparatus independently of the transmitting portion, and the receiving apparatus preferably further includes an image receiving portion for receiving the image of the computer from the image transmitting portion independently of the receiving portion. According to this structure, the operating information and information of the image of the PC 1 can be transmitted and received via different pathways so that the operating information and the image of the PC 1 can be further reliably transmitted and received. According to this structure, the operating information and information of the image of the computer can be transmitted and received via different pathways so that the operating information and the image of the computer can be further reliably transmitted and received.

In this case, the computer preferably transmits the operating information to the receiving portion of the receiving apparatus through the transmitting portion when the user sets the computer to transmit the operating information, and the computer preferably analyzes the operating information and prepares the image of the computer to transmit the image of the computer to the image receiving portion of the receiving apparatus through the image transmitting portion when the user sets the computer not to transmit the operating information. According to this structure, the user can operate the receiving apparatus by transmitting the operating information to the receiving apparatus when the user sets the computer to transmit the operating information, and the user can operate the computer by analyzing the operating information when the user sets the computer not to transmit the operating information.

In the aforementioned information display system according to the first aspect, the computer preferably transmits both the image of the computer and the operating information through the transmitting portion, and the receiving portion of the receiving apparatus preferably receives both the image of the computer and the operating information. According to this structure, the transmitting and receiving portions for transmitting and receiving the image of the computer and the operating information can be shared so that the number of components in the information display system can be inhibited from increase.

The aforementioned information display system according to the first aspect preferably further comprises display means for visually informing the user whether to transmit the operating information from the computer to the receiving apparatus. According to this structure, the user can visually recognize whether to transmit the operating information from the computer to the receiving apparatus. Thus, the user can visually check to be operating the computer or the receiving apparatus so that an operation different from an operation intended by the user can be inhibited from being performed in the information display system.

In this case, the display means preferably displays a notice that the operating information has not been received on the display portion when the user sets the receiving apparatus to transmit the operating information and the operating information is not transmitted from the computer to the receiving apparatus. According to this structure, when the operating information is not transmitted from the computer to the receiving apparatus due to a disconnection between the input device and the computer or the like, the user is informed that the operating information is not being received, whereby the user can be prompted to make a connection between the input device and the computer or the like in order to transmit the operating information from the computer to receiving apparatus.

The aforementioned information display system according to the first aspect preferably further comprises a remote controller for allowing the user to operate the receiving apparatus, wherein the control portion of the receiving apparatus is preferably formed to be capable of prioritizing processing based on an operation of the remote controller by the user over processing based on the operating information of the input device. According to this structure, when the receiving apparatus is operated with both the remote controller and the input device by the user, processing based on the operation of the remote controller by the user is prioritized, whereby an operation different from an operation intended by the user due to an operation of the input device not intended by the user can be inhibited from being performed in the information display system.

In the aforementioned information display system according to the first aspect, the operating information preferably includes information regarding a movement amount of the input device, the display portion preferably displays an image on which display processing is performed by the control portion of the receiving apparatus such that the cursor moves between a plurality of selection icons, and the control portion of said receiving apparatus preferably performs the display processing such that the cursor moves between the plurality of selection icons every the prescribed movement amount. According to this structure, the cursor can be easily moved on the basis of the prescribed movement amount of the input device also when the cursor is displayed to move between the plurality of selection icons.

An information display apparatus according to a second aspect of the present invention comprises a receiving apparatus including a receiving portion for receiving operating information of an input device transmitted by a computer connected with the input device to which a user inputs the operating information and a control portion capable of performing display processing of a cursor on the basis of the operating information of the input device, and a display portion capable of displaying an image and displaying an image on which the display processing for composing the cursor with an image is performed by the control portion of the receiving apparatus on the basis of the operating information of the input device, wherein the user can set whether to transmit the operating information from the computer to the receiving apparatus.

In the information display apparatus according to the second aspect of the present invention, as hereinabove described, the receiving apparatus includes the control portion capable of performing the display processing of the cursor on the basis of the operating information of the input device. Thus, processing to the receiving apparatus regarding an operation based on the operating information of the input device can be performed in the control portion of the receiving apparatus so that the processing to the receiving apparatus regarding an operation based on the operating information of the input device may not be performed in the computer. As a result, processing in the computer can be inhibited from increase so that a load applied to the computer can be inhibited from increase.

Further, as hereinabove described, the user can set whether to transmit the operating information from the computer to the receiving apparatus, whereby the user can set the operating information not to be transmitted from the computer to the receiving apparatus when the operating information from the computer to the receiving apparatus is not necessary. Thus, the unnecessary operating information can be inhibited from being transmitted to the receiving apparatus so that a load applied to the receiving apparatus can be inhibited from increase.

In the aforementioned information display apparatus according to the second aspect, the receiving apparatus preferably includes a television apparatus or a set top box. According to this structure, whether to transmit the operating information from the computer to the receiving apparatus can be set with the receiving apparatus including the television apparatus or the set top box.

In the aforementioned information display apparatus according to the second aspect, the input device preferably includes a pointing device, and the operating information preferably includes information regarding a position of the pointing device, and the control portion of the receiving apparatus is preferably formed to compose the cursor with an image on the basis of the information regarding a position of the pointing device. According to this structure, the control portion of the receiving apparatus can compose the cursor with an image on the basis of the information regarding a position of the pointing device that the user can intuitively operate as compared with an input device such as a keyboard and a remote controller. Thus, operability for the user in operating the receiving apparatus can be improved.

In this case, the information display apparatus preferably further comprises a conversion portion for converting the information regarding a position of the pointing device so that the cursor can be composed with an image when a screen resolution set in the computer and a screen resolution set in the receiving apparatus are different from each other. According to this structure, the control portion of the receiving apparatus can perform display processing for composing the cursor with an image and allow display of the display-processed image on the basis of the converted information regarding a position of the pointing device also when the screen resolution set in the computer and the screen resolution set in the receiving apparatus are different from each other.

The aforementioned information display apparatus according to the second aspect preferably further comprises display means for visually informing the user whether to transmit the operating information from the computer to the receiving apparatus. According to this structure, the user can visually recognize whether to transmit the operating information from the computer to the receiving apparatus. Thus, the user can visually check to be operating the computer or the receiving apparatus so that an operation different from an operation intended by the user can be inhibited from being performed in the information display apparatus.

The aforementioned information display apparatus according to the second aspect preferably further comprises a remote controller for allowing the user to operate the receiving apparatus, wherein the control portion of the receiving apparatus is preferably formed to be capable of prioritizing processing based on an operation of the remote controller by the user over processing based on the operating information of the input device. According to this structure, when the receiving apparatus is operated with both the remote controller and the input device by the user, processing based on the operation of the remote controller by the user is prioritized, whereby an operation different from an operation intended by the user due to an operation of the input device not intended by the user can be inhibited from being performed in the information display apparatus.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 illustrates the overall structure of an information display system according to a first embodiment of the present invention;

FIG. 2 is a block diagram showing the overall structure of the information display system shown in FIG. 1;

FIG. 3 illustrates a state of displaying a screen for selecting an operation from a mouse of a PC image and a PC cursor on a display portion of a TV of the information display system shown in FIG. 1;

FIG. 4 illustrates a state of displaying an icon and a TV cursor on the display portion of the TV of the information display system shown in FIG. 1;

FIG. 5 illustrates a state of displaying an EPG on the display portion of the TV of the information display system shown in FIG. 1;

FIG. 6 illustrates a state of having downwardly scrolled the EPG shown in FIG. 5;

FIG. 7 illustrates a state of displaying a message that a signal from the mouse is not input on the display portion of the TV of the information display system shown in FIG. 1;

FIG. 8 illustrates a state of displaying a message showing that the TV is in a mode of not accepting the operation from the mouse on the display portion of the TV of the information display system shown in FIG. 1;

FIG. 9 is a diagram showing a control flow of a PC of the information display system shown in FIG. 1;

FIG. 10 is a diagram showing a control flow of the TV of the information display system shown in FIG. 1;

FIG. 11 illustrates the overall structure of an information display system according to a second embodiment of the present invention;

FIG. 12 is a block diagram showing the overall structure of the information display system shown in FIG. 11;

FIG. 13 is a diagram showing a control flow of a PC of the information display system shown in FIG. 11;

FIG. 14 is a diagram showing a control flow of an STB of the information display system shown in FIG. 11;

FIG. 15 illustrates a state of displaying an icon and a selection cursor on a display portion of the information display system according to a modification of the first and second embodiments of the present invention; and

FIG. 16 illustrates a state of having upwardly moved the selection cursor on the display portion shown in FIG. 15 by a distance from an option to the next option of the icon.

### DESCRIPTION OF THE PREFERRED EMBODIMENTS

Embodiments of the present invention are now described with reference to the drawings.

### First Embodiment

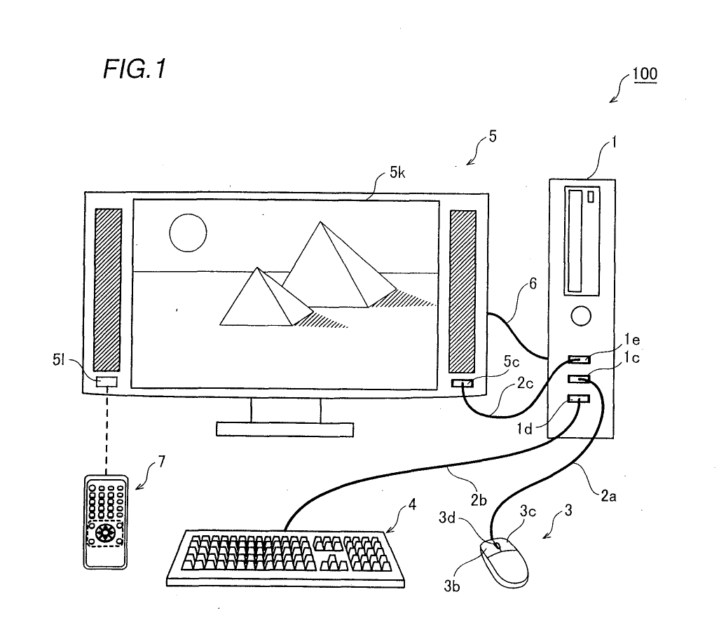

First, the structure of an information display system 100 according to a first embodiment of the present invention is described with reference to FIGS. 1 to 8.

In the information display system 100 according to the first embodiment of the present invention, as shown in FIG. 1, a mouse 3 is connected to a personal computer (PC) 1 through a USB cable 2a, a keyboard 4 is connected to the PC 1 through a USB cable 2b, and a television apparatus (TV) 5 is connected to the PC 1 through a USB cable 2c. The PC 1 and the TV 5 are connected to each other also through an HDMI (High-Definition Multimedia Interface) cable 6. A PC image prepared in the PC 1 is transmitted from the PC 1 to the TV 5 through the HDMI cable 6. The information display system 100 comprises a remote controller 7 for operating the TV 5. This remote controller 7 is so formed as to be capable of externally outputting a signal regarding an operation of the TV 5 as an infrared ray. The television apparatus (TV) 5 is an example of each of the “receiving apparatus” and the “information display apparatus” in the present invention.

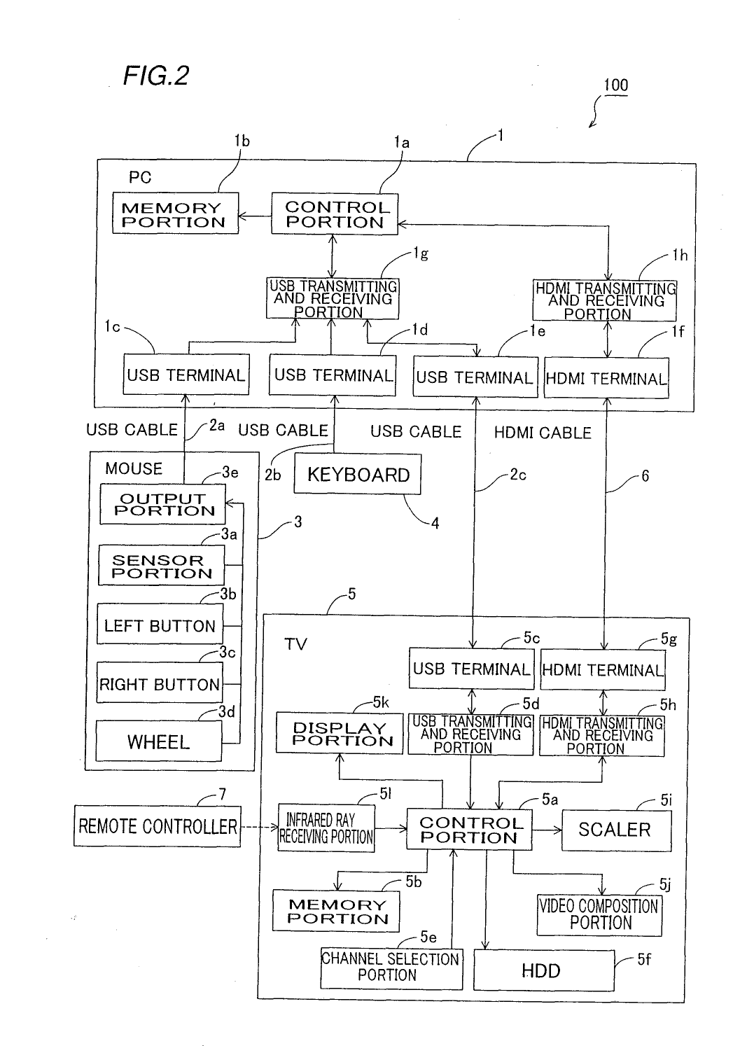

The mouse 3 is provided with a sensor portion 3a detecting a change of a relative position of the mouse 3 generated by being moved by a user as information regarding a position of the mouse 3, a left button 3b detecting a push-down operation by the user as a so-called “left click”, a right button 3c detecting a push-down operation by a user as a so-called “right click”, and a wheel 3d so formed as to be rotated by the user and detecting a rotating operation by the user, as shown in FIG. 2. The mouse 3 is further provided with an output portion 3e for outputting the detected change of a relative position of the mouse, the left click, the right click and rotation of the wheel 3d as positional information, left click information, right click information and scrolling information, respectively, to the PC 1. Let the left click information, the right click information and the scrolling information be operational control information. The keyboard 4 is so formed as to output information allocated to each key (not shown) as a signal to the PC 1 through the USB cable 2b when each key is pressed down. The mouse 3 is an example of each of the “input device” and the “pointing device” in the present invention. Each of the positional information, the left click information, the right click information and the scrolling information is an example of the “operating information” in the present invention.

The PC 1 is provided with a control portion 1a and a memory portion 1b constituted by a hard disk or a nonvolatile memory such as a flash memory as shown in FIG. 2. The PC 1 is further provided with USB terminals 1c to 1e and an HDMI terminal 1f. This USB terminal 1c is connected to the output portion 3e of the mouse 3 through the USB cable 2a. The USB terminal 1d is connected to the keyboard 4 through the USB cable 2b. The USB terminal 1e is connected to a USB terminal 5c of the TV 5 described later through the USB cable 2c. The HDMI terminal 1f is connected to an HDMI terminal 5g of the TV 5 described later through the HDMI cable 6. Each of the USB terminals 1c, 1d and 1e is connected to a USB transmitting and receiving portion 1g, and the HDMI terminal 1f is connected to an HDMI transmitting and receiving portion 1h. Signals are transmitted from the USB transmitting and receiving portion 1g to the USB cables 2a, 2b and 2c through the USB terminals 1c, 1d and 1e, respectively, by the control portion 1a. Signals are transmitted from the HDMI transmitting and receiving portion 1h to the HDMI cable 6 through the HDMI terminal 1f by the control portion 1a. In the PC 1, the USB transmitting and receiving portion 1g receives signals from the USB cables 2a, 2b and 2c, and the HDMI transmitting and receiving portion 1h receives a signal from the HDMI cable 6.

According to the first embodiment, the memory portion 1b stores a driver and an application as programs, and the driver and the application enable the control portion 1a to allow the USB transmitting and receiving portion 1g to receive the operating information constituted by the positional information, the left click information, the right click information and the scrolling information of the mouse 3 through the USB terminal 1c. When the PC 1 and the TV 5 are connected to each other through the USB cable 2c, these driver and application are automatically transmitted from the TV 5 thereby being received by the USB transmitting and receiving portion 1g. The memory portion 1b is an example of the “second memory portion” in the present invention, and the USB transmitting and receiving portion 1g is an example of each of the “transmitting portion” and the “program receiving portion” in the present invention.

The user can set whether to transmit the operating information of the mouse 3 from the USB transmitting and receiving portion 1g through the USB terminal 1e in the PC 1 on the basis of the driver and the application stored in the memory portion 1b. When the user sets the PC 1 to transmit the operating information from the USB transmitting and receiving portion 1g, the operating information is transmitted from the USB transmitting and receiving portion 1g through the USB terminal 1e by the control portion 1a of the PC 1 on the basis of the driver and the application stored in the memory portion 1b. At this time, the operating information is not analyzed in the control portion 1a and is transmitted (passes through) from the USB transmitting and receiving portion 1g through the USB terminal 1e. The positional information is set so as to correspond to a screen resolution of 800×600 set in the PC 1, and a signal including data regarding the positional information corresponding to the screen resolution (800×600) set in the PC 1 is transmitted through the USB cable 2c.

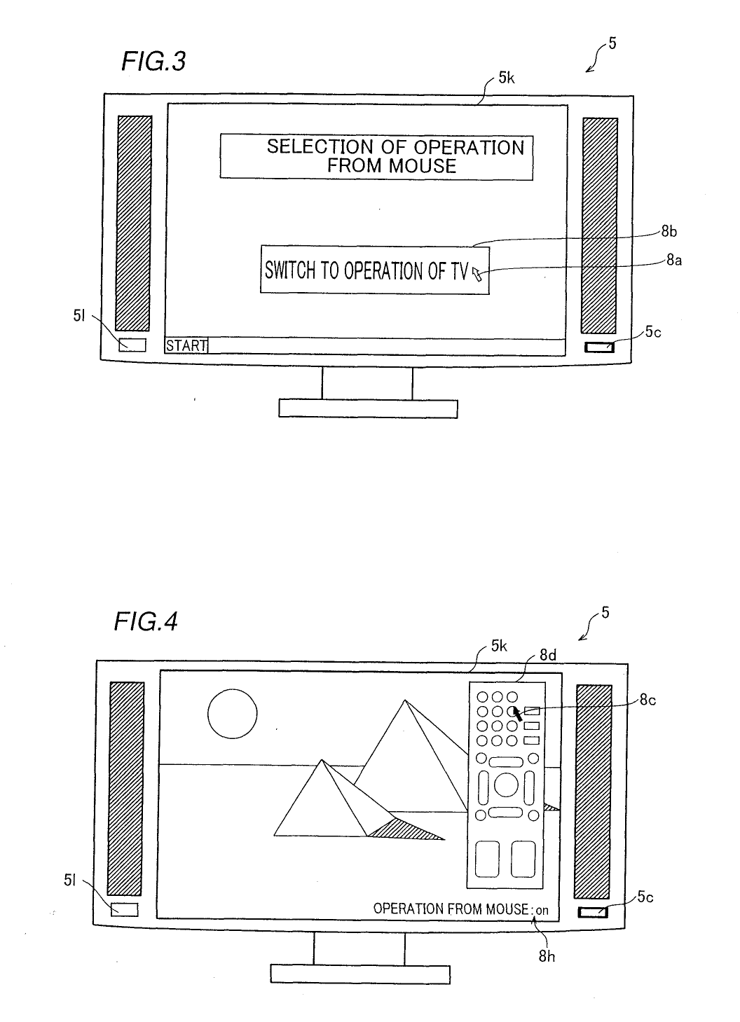

In procedure for specific setting, as shown in FIG. 3, the PC image is prepared in the PC 1 (see FIG. 2) on the basis of the driver and the application stored in the memory portion 1b (see FIG. 2) such that a screen for selecting an operation from a mouse and an outlined arrow-shaped PC cursor 8a are displayed, in a state of not transmitting the operating information of the mouse 3 from the USB transmitting and receiving portion 1g through the USB terminal 1e in the PC 1. The PC image is transmitted from the HDMI transmitting and receiving portion 1h (see FIG. 2) to the TV 5 through the HDMI terminal 1f (see FIG. 2) thereby being displayed on a display portion 5k of the TV 5 described later. When the user inputs the left click information in a state of positioning the PC cursor 8a on an icon 8b to which processing for switching to an operation of the TV 5 on the screen for selecting an operation from a mouse is allocated, the icon 8b is selected and the processing for switching to an operation of the TV 5 is performed by the control portion 1a (see FIG. 2) of the PC 1. In other words, it switches to processing in which the operating information is transmitted (passes through) from the USB transmitting and receiving portion 1g (see FIG. 2) through the USB terminal 1e (see FIG. 2) by the control portion 1a of the PC 1 on the basis of the driver and the application stored in the memory portion 1b without analysis by the control portion 1a. The HDMI terminal 1f is an example of the “image transmitting portion” in the present invention.

When the user sets the PC 1 not to transmit the operating information of the mouse 3 from the USB terminal 1e through the USB transmitting and receiving portion 1g, the operating information is analyzed by the control portion 1a and the processing in the PC 1 is performed, as shown in FIG. 2. The PC image prepared by the processing in the PC 1 is transmitted from the HDMI transmitting and receiving portion 1h to the TV 5 through the HDMI terminal 1f. A signal having information of the screen resolution (800×600) set in the PC 1 can be transmitted from the HDMI transmitting and receiving portion 1h to the TV 5 through the HDMI terminal 1f.

The TV 5 is provided with a control portion 5a, a memory portion 5b constituted by a nonvolatile memory such as a flash memory and storing a program or the like used in the control portion 5a, the USB terminal 5c, and a USB transmitting and receiving portion 5d connected to the USB terminal 5c as shown in FIG. 2. A signal is transmitted from the USB transmitting and receiving portion 5d to the USB cable 2c through the USB terminal 5c by the control portion 5a. The USB transmitting and receiving portion 5d receives a signal from the USB cable 2c in the TV 5. The memory portion 5b stores a driver and an application transmitted from the USB transmitting and receiving portion 5d to the memory portion 1b of the PC 1 through the USB cable 2c by the control portion 5a, as programs. The memory portion 5b is an example of the “first memory portion” in the present invention, and the USB transmitting and receiving portion 5d is an example of each of the “receiving portion” and the “program transmitting portion” in the present invention.

According to the first embodiment, in the TV 5, the user can set whether the USB transmitting and receiving portion 5d receives the operating information constituted by the positional information, the left click information, the right click information and the scrolling information of the mouse 3 through the USB terminal 5c. Specifically, a prescribed operation is performed on the remote controller 7 by the user, whereby whether the USB transmitting and receiving portion 5d receives the operating information through the USB terminal 5c is set.

When the operating information is set so as to be received by the USB transmitting and receiving portion 5d through the USB terminal 5c, the control portion 5a allows the USB transmitting and receiving portion 5d to receive the operating information through the USB terminal 5c. When the operating information is set so as not to be received by the USB transmitting and receiving portion 5d through the USB terminal 5c, on the other hand, the control portion 5a does not allow the USB transmitting and receiving portion 5d to receive the operating information through the USB terminal 5c.

Further, the TV 5 is provided with a channel selection portion 5e, a hard disk driver (HDD) 5f, the HDMI terminal 5g and an HDMI transmitting and receiving portion 5h connected to the HDMI terminal 5g as shown in FIG. 2. This channel selection portion 5e can receive each of a television broadcast and an electronic program guide (EPG) regarding the television broadcast from an antenna not shown. The HDD 5f can record the received television broadcast with reference to the EPG.

A signal is transmitted from the HDMI transmitting and receiving portion 5h to the HDMI cable 6 through the HDMI terminal 5g by the control portion 5a. Thus, the control portion 5a determines whether a signal for confirming whether the PC 1 is in an ON-state has been transmitted from the HDMI transmitting and receiving portion 5h and a reply has been sent from the PC 1 to the HDMI transmitting and receiving portion 5h, whereby whether a power source of the PC 1 is in an ON-state can be confirmed. When the power source of the PC 1 is not in an ON-state (but is in an OFF-state), a signal for powering on the PC 1 is transmitted from the HDMI transmitting and receiving portion 5h through the HDMI terminal 5g by the control portion 5a, whereby the PC 1 can be powered on without an operation by the user. When the signal having information of the screen resolution (800×600) set in the PC 1 has been received by the HDMI transmitting and receiving portion 5h, the screen resolution (800×600) set in the PC 1 is recognized by the control portion 5a. The HDMI transmitting and receiving portion 5h is an example of the “image receiving portion” in the present invention.

According to the first embodiment, the TV 5 is provided with a scaler 5i, a video composition portion 5j and the display portion 5k having a screen resolution of 1920×1080. In this scaler 5i, the positional information prepared on the basis of the screen resolution (800×600) set in the PC 1 is converted to conform to the screen resolution (1920×1080) set in the display portion 5k by the control portion 5a. Thus, the positional information can be displayed on the display portion 5k. The scaler 5i is an example of the “conversion portion” in the present invention.

In a conversion method of the positional information of the mouse 3, each of longitudinal and horizontal ratios of the screen resolution (1920×1080) set in the TV 5 to the screen resolution (800×600) set in the PC 1 is calculated. In the scaler 5i, the positional information prepared on the basis of the screen resolution (800×600) set in the PC 1 is converted to conform to the screen resolution (1920×1080) set in the display 5k by the control portion 5a on the basis of the calculated longitudinal and horizontal ratios. According to the first embodiment, the longitudinal ratio is 1920/800=2.4, and the horizontal ratio is 1080/600=1.8. The positional information of the mouse 3 is converted by the control portion 5a on the basis of these longitudinal and horizontal ratios. For example, a coordinate in the PC 1 representing a position of the mouse 3 is assigned on the basis of the upper left (PC [0, 0]), and a coordinate in the TV 5 representing a position of the mouse 3 is assigned on the basis of the upper left (TV [0, 0]). When the positional information of the mouse 3 in the PC 1 is PC [1, 1], the positional information of the mouse 3 in the TV 5 is converted to TV [1×2.4, 1×1.8]=TV [2.4, 1.8]. These numbers are rounded off to the closest whole number, whereby eventually, PC [1, 1], which is the positional information of the mouse 3 in the PC 1, is converted to TV [2, 2].

In the video composition portion 5j of the TV 5, a TV cursor 8c (see FIG. 4) prepared on the basis of the converted positional information is composed so as to overlap a TV image displayed on the display portion 5k by the control portion 5a. The display-processed TV image including the TV cursor 8c is displayed on the display portion 5k.

Specifically, the television broadcast is displayed on the display portion 5k of the TV 5 while a remote controller-shaped icon 8d is displayed as an OSD (On Screen Display) on the same, as shown in FIG. 4. The arrow-shaped TV cursor 8c prepared by the control portion 5a in the video composition portion 5j (see FIG. 2) is also displayed on the display portion 5k of the TV 5. This TV cursor 8c is composed with the TV image of the television broadcast and the icon 8d. The TV cursor 8c is composed with the TV image of the television broadcast and the icon 8d by the control portion 5a (see FIG. 2) on the positional information received by the USB transmitting and receiving portion 5d (see FIG. 2) to be displayed on the display portion 5k. For example, when the user moves the mouse 3 (see FIG. 2) to the left, the movement of the mouse 3 to the left is recognized as the change of the relative position of the mouse 3 and is transmitted as the positional information to the TV 5. Thereafter, the TV cursor 8c is composed with the TV image of the television broadcast and the icon 8d by the control portion 5a on the basis of the positional information converted in the scaler 5i (see FIG. 2). Thus, the TV cursor 8c is displayed on the display portion 5k so as to move to the left. The TV cursor 8c is an example of the “cursor” in the present invention.

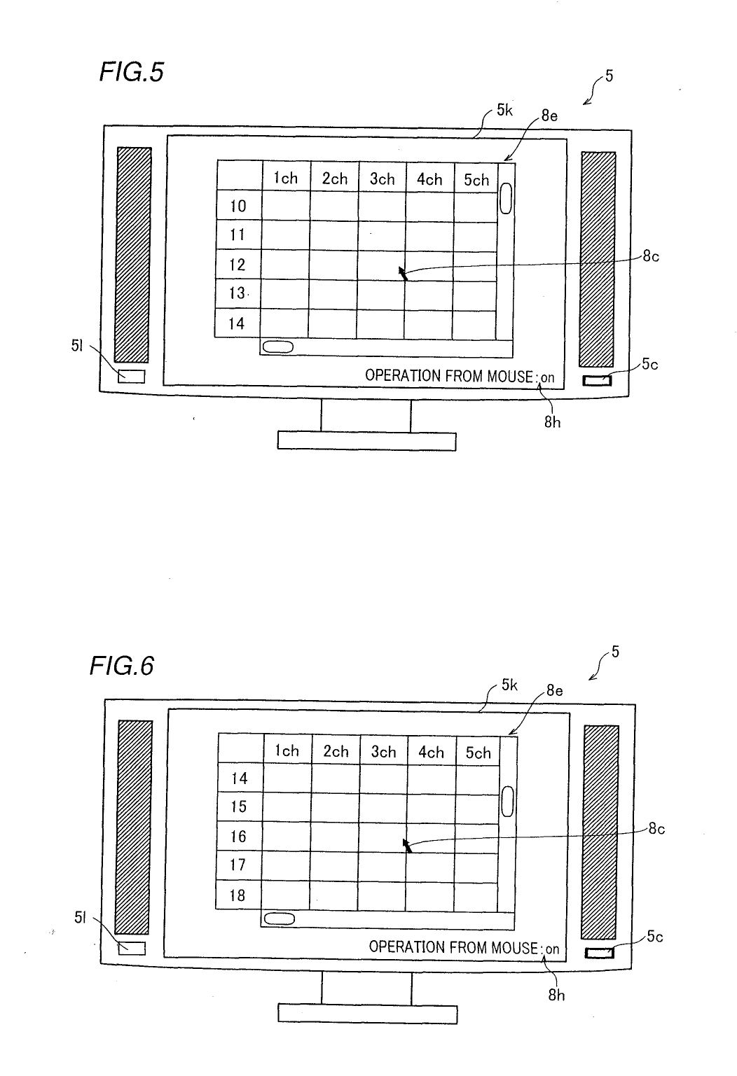

When the USB transmitting and receiving portion 5d receives the left click information in a state of positioning the TV cursor 8c on a prescribed position of the icon 8d, processing set on a position where the TV cursor 8c is positioned is performed by the control portion 5a on the basis of the received left click information. For example, when processing in which the EPG is retrieved by the control portion 5a is set on the icon 8d where the TV cursor 8c is positioned as shown in FIG. 4, the left click of the mouse 3 is transmitted as the left click information to the TV 5 and the processing in which the EPG is retrieved by the control portion 5a is performed when the user pushes down the left button 3b (see FIG. 2) of the mouse 3. Thus, an EPG 8e is displayed on the display portion 5k instead of the television broadcast and the remote controller-shaped icon 8d (see FIG. 4) as shown in FIG. 5.

When the left click information is received by the USB transmitting and receiving portion 5d (see FIG. 2) in a state where the TV cursor 8c selects a program on the EPG 8e while the EPG 8e is displayed on the display portion 5k, processing regarding a recording reservation of the program selected by the TV cursor 8c is performed by the control portion 5a on the basis of the received left click information. When the scrolling information is received by the USB transmitting and receiving portion 5d in a state where the EPG 8e is displayed on the display portion 5k, processing for vertically scrolling and displaying the EPG 8e is performed by the control portion 5a on the basis of the received scrolling information. When the user rotates the wheel 3d (see FIG. 2) downwardly in the state where the EPG 8e is displayed on the display portion 5k, for example, the downward rotation of the wheel 3d is transmitted as the scrolling information to the TV 5 and processing for downwardly scrolling the EPG 8e and displaying the same on the display portion 5k is performed by the control portion 5a. Thus, the display of the EPG 8e changes from a state shown in FIG. 5 to a state shown in FIG. 6.

The TV 5 is further provided with an infrared ray receiving portion 5l receiving an infrared ray output from the remote controller 7 as shown in FIG. 2. The control portion 5a of the TV 5 performs various controls of the TV 5 on the basis of signals regarding the operations of the TV 5 included in the infrared ray output from the remote controller 7. Specifically, the control portion 5a performs controls regarding turning up and down the sound volume, channel switching of the television broadcast, and an operation about whether to allow the USB transmitting and receiving portion 5d to receive the operating information constituted by the positional information, the left click information, the right click information and the scrolling information of the mouse 3 through the USB terminal 5c and so on.

In the TV 5, both of an operation of the TV 5 from the remote controller 7 and an operation of the TV 5 from the mouse 3 based on the operating information of the mouse 3 can be accepted. The control portion 5a of the TV 5 can prioritize the operation of the TV 5 from the remote controller 7 on the basis of a prescribed operation performed on the remote controller 7 by the user and can prevent acceptance of the operation of the TV 5 from the mouse 3.

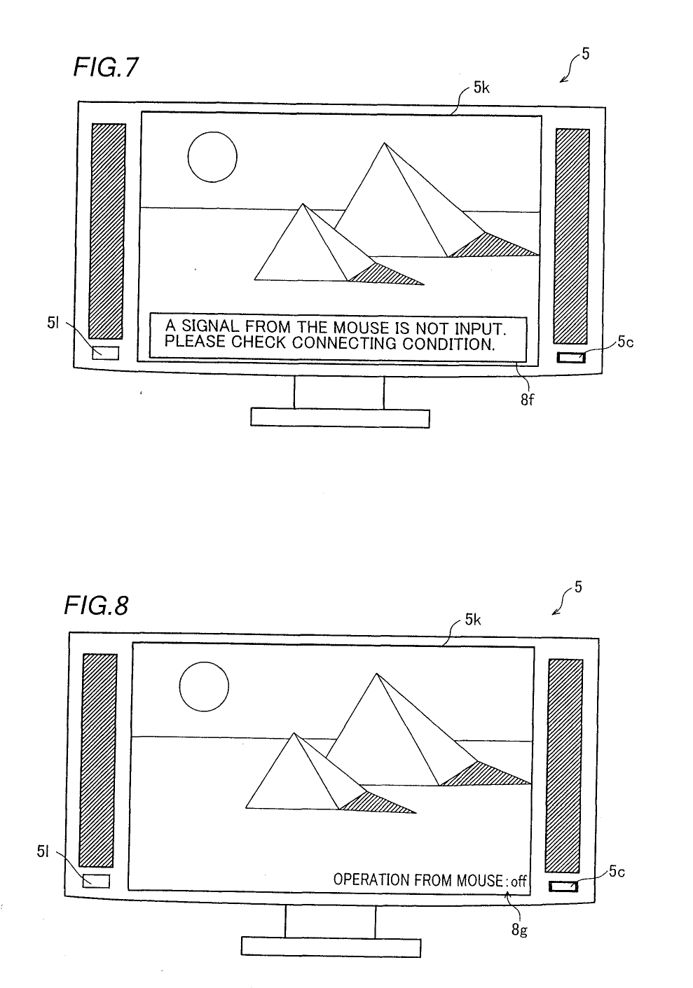

When the operating information from the mouse 3 is not input to the TV 5, a message 8f that a signal from the mouse 3 (see FIG. 2) is not input is displayed on the display portion 5k by the control portion 5a (see FIG. 2) as shown in FIG. 7. Specifically, this message 8f is displayed when the control portion 1a (see FIG. 2) of the PC 1 (see FIG. 2) is set so as not to transmit the operating information from the USB transmitting and receiving portion 1g (see FIG. 2) through the USB terminal 1e (see FIG. 2), or the mouse 3 is not connected to the PC 1 and the operating information is not output from the USB transmitting and receiving portion 1g of the PC 1.

When the operating information from the mouse 3 is input whereas the TV 5 is not set so as to receive the operating information, a message 8g showing that the TV 5 is in a mode of not accepting the operation from the mouse 3 (see FIG. 2) is displayed on the display portion 5k by the control portion 5a (see FIG. 2), as shown in FIG. 8. Specifically, this message 8g is displayed when the control portion 5a of the TV 5 is set so that the USB transmitting and receiving portion 5d (see FIG. 2) receives the operating information, or the control portion 5a of the TV 5 is set so as to prioritize the operation of the TV 5 from the remote controller 7 and prevent acceptance of the operation of the TV 5 from the mouse 3 on the basis of the prescribed operation performed on the remote controller 7 (see FIG. 2) by the user.

When the operating information from the mouse 3 is input to the TV 5 and the TV 5 is set so as to receive the operating information, a message 8h showing that the TV 5 is in a mode of accepting the operation from the mouse 3 (see FIG. 2) is displayed on the display 5k by the control portion 5a (see FIG. 2), as shown in FIGS. 4 to 6.

The PC image prepared by the processing in the PC 1 is received by the HDMI transmitting and receiving portion 5h (see FIG. 2) through the HDMI terminal 5g (see FIG. 2) thereby being displayed on the display portion 5k by the control portion 5a (see FIG. 2) as shown in FIG. 3.

In the first embodiment, 10 bits as an amount of data for showing a lateral direction (800) and 10 bits as an amount of data for showing a longitudinal direction (600) are needed on the basis of the screen resolution (800×600) set in the PC 1 in order to transmit the positional information, and it is necessary to transmit two information of having been pushed down and not having been pushed down in order to transmit each of the left click information and the right click information, so that 1 bit is needed for each of the left click information and the right click information and 2 bits in total are needed. It is necessary to transmit three information of upward scrolling information, downward scrolling information and information of not having been operated in order to transmit the scrolling information with the USB cable, so that 2 bits are needed. In other words, at least 24 bits are needed to transmit signals regarding the operating information (positional information, left click information, right click information and scrolling information) of the mouse 3 with the USB cable.

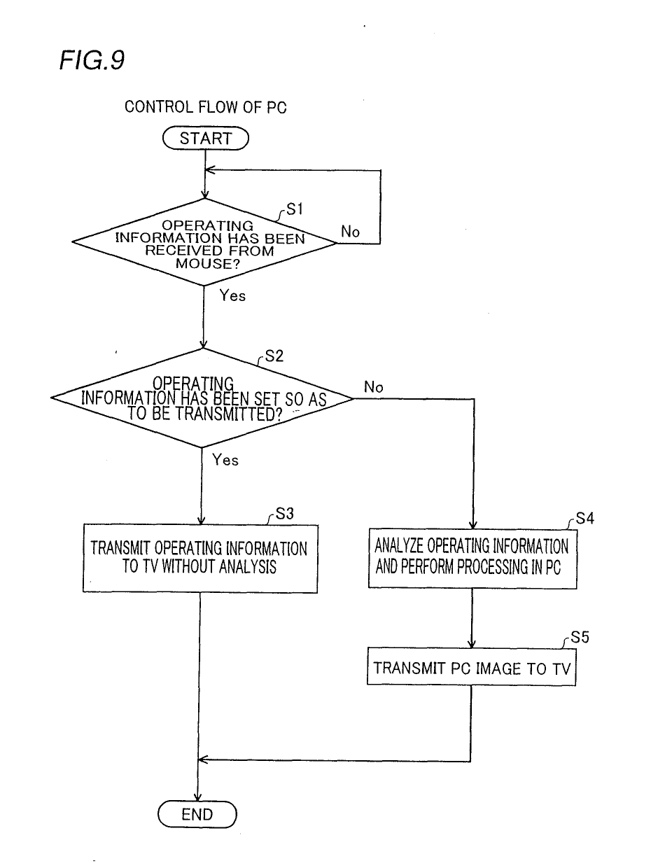

Next, the control flow of the PC 1 of the information display system 100 according to the first embodiment of the present invention is described with reference to FIGS. 2 and 9.

As shown in FIG. 9, the control portion 1a (see FIG. 2) of the PC 1 determines whether the operating information constituted by the positional information, the left click information, the right click information and the scrolling information input by the user through the mouse 3 (see FIG. 2) has been input to the USB transmitting and receiving portion 1g (see FIG. 2) through the USB terminal 1c (see FIG. 2) at a step S1, and the determination at the step S1 is repeated until the operating information has been input to the USB transmitting and receiving portion 1g. When the control portion 1a determines that the operating information has been input to the USB transmitting and receiving portion 1g at the step S1, the process advances to a step S2.

At the step S2, the control portion 1a determines whether the operating information input to the USB transmitting and receiving portion 1g through the mouse 3 has been set so as to be transmitted from the USB transmitting and receiving portion 1g through the USB terminal 1e (see FIG. 2) on the basis of the driver and the application stored in the memory portion 1b (see FIG. 2). When the control portion 1a determines that the operating information has been set so as to be transmitted at the step S2, the operating information is not analyzed by the control portion 1a and is transmitted from the USB transmitting and receiving portion 1g to the TV 5 (see FIG. 2) through the USB terminal 1e at a step S3. Then, the control by the control portion 1a of the PC 1 is terminated. When the control portion 1a determines that the operating information has not been set so as to be transmitted at the step S2, the process advances to a step S4.

At the step S4, the operating information of the mouse 3 is analyzed by the control portion 1a and the processing is performed in the PC 1. At a step S5, the PC image prepared by the processing in the PC 1 is transmitted from the HDMI transmitting and receiving portion 1h (see FIG. 2) to the TV 5 through the HDMI terminal 1f (see FIG. 2). Then, the control by the control portion 1a of the PC 1 is terminated.

Next, the control flow of the TV 5 of the information display system 100 according to the first embodiment of the present invention is described with reference to FIGS. 2 to 8 and 10.

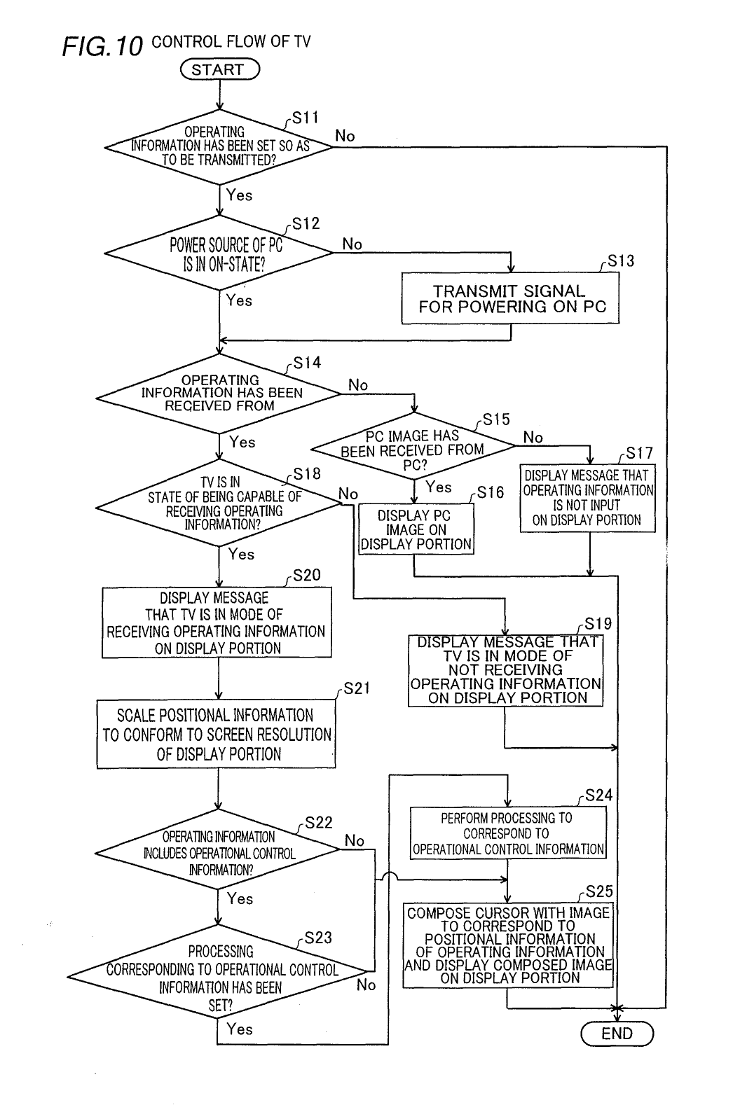

As shown in FIG. 10, the control portion 5a (see FIG. 2) of the TV 5 determines whether the operating information constituted by the positional information, the left click information, the right click information and the scrolling information from the mouse 3 (see FIG. 2) has been set so as to be received by the USB transmitting and receiving portion 5d (see FIG. 2) through the USB terminal 5c (see FIG. 2) at a step S11. When the control portion 5a determines that the operating information from the mouse 3 has been set so as to be received at the step S11, the process advances to a step S12. When the control portion 5a determines that the operating information from the mouse 3 has not been set so as to be received at the step S11, the control by the control portion 5a of the TV 5 is terminated.

At a step S12, the control portion 5a determines whether the signal for confirming whether the power source of the PC 1 (see FIG. 2) is in an ON-state has been transmitted from the HDMI transmitting and receiving portion 5h (see FIG. 2) through the HDMI terminal 5g (see FIG. 2) and the reply has been sent from the PC 1, whereby whether the PC 1 is in an ON-state is determined. When the control portion 5a determines that the PC 1 is not in an ON-state (but is in an OFF-state) at the step S12, the signal for powering on the PC 1 is transmitted from the HDMI transmitting and receiving portion 5h through the HDMI terminal 5g at a step S13. Thus, the PC 1 is powered on and enters an ON-state. When the control portion 5a determines that the power source of the PC 1 is in an ON-state at the step S12, the process advances to a step S14.

At the step S14, the control portion 5a determines whether the operating information from the mouse 3 has been received by the USB transmitting and receiving portion 5d through the USB terminal 5c. When the control portion 5a determines that the operating information has not been received at the step S14 (when the control portion 1a (see FIG. 2) of the PC 1 is set so as not to transmit the operating information from the USB transmitting and receiving portion 1g (see FIG. 2) through the USB terminal 1e (see FIG. 2), or the mouse 3 is not connected to the PC 1 and the operating information is not output from the USB transmitting and receiving portion 1g), the process advances to a step S15. When the control portion 5a determines that the operating information has been received at the step S14, the process advances to a step S18.

At the step S15, the control portion 5a determines whether the PC image prepared by the processing in the PC 1 has been received by the HDMI transmitting and receiving portion 5h through the HDMI terminal 5g. When the control portion 5a determines that the PC image has been received at the step S15, the PC image as shown in FIG. 3 is displayed on the display portion 5k at a step S16. Then, the control by the control portion 5a of the TV 5 is terminated. When the control portion 5a determines that the PC image has not been received at the step S15, the message 8f that a signal from the mouse 3 is not input as shown in FIG. 7 (“A signal from the mouse is not input. Please check connecting condition.”) is displayed on the display portion 5k at a step S17. Then, the control by the control portion 5a of the TV 5 is terminated.

At a step S18, the control portion 5a determines whether the TV 5 is in a state of being capable of receiving the operating information of the mouse 3. When the control portion 5a determines that the TV 5 is not in a state of being capable of receiving the operating information at the step S18 (when the operating information is output from the USB transmitting and receiving portion 1g of the PC 1 whereas the control portion 5a of the TV 5 is set so that the USB transmitting and receiving portion 5d does not receive the operating information, or the control portion 5a of the TV 5 is set so as to prioritize the operation of the TV 5 from the remote controller 7 and prevent acceptance of the operation of the TV 5 from the mouse 3 on the basis of the prescribed operation performed on the remote controller 7 (see FIG. 2) by the user), the message 8g showing that the TV 5 is in a mode of not accepting the operation from the mouse 3 as shown in FIG. 8 (“operation from mouse: off”) is displayed on the display portion 5k by the control portion 5a at a step S19. Then, the control by the control portion 5a of the TV 5 is terminated. When the control portion 5a determines that the TV 5 is in a state of being capable of receiving the operating information at the step S18, the process advances to a step S20.

At the step S20, the message 8h showing that the TV 5 is in a mode of accepting the operation from the mouse 3 as shown in FIGS. 4 to 6 (“operation from mouse: on”) is displayed on the display 5k by the control portion 5a. At a step S21, the positional information prepared on the basis of the screen resolution (800×600) set in the PC 1 is converted to conform to the screen resolution (1920×1080) set in the display portion 5k in the scaler 5i (see FIG. 2). The process advances to a step S22.

At the step S22, the control portion 5a determines whether the received operating information includes the operational control information constituted by the left click information, the right click information and the scrolling information. When the control portion 5a determines that the received operating information includes the operational control information at the step S22, the process advances to a step S23. When the control portion 5a determines that the received operating information does not include the operational control information at the step S22, the process advances to a step S25.

At a step S23, the control portion 5a determines whether the processing corresponding to the received operational control information has been set on a position where the TV cursor 8c (see FIGS. 4 to 6) is displayed. When the control portion 5a determines that the processing corresponding to the received operational control information has been set on a position where the TV cursor 8c is displayed at the step S23, the process advances to a step S24. When the control portion 5a determines that the processing corresponding to the received operational control information has not been set on a position where the TV cursor 8c is displayed, determined on the basis of the positional information at the step S23, the process advances to a step S25.

At the step S24, the processing set on a position where the TV cursor 8c is displayed is performed by the control portion 5a to correspond to the received operational control information. Finally, at the step S25, the converted positional information is composed so as to overlap the TV image displayed on the display portion 5k as the TV cursor 8c, and the display-processed TV image including the TV cursor 8c is displayed on the display portion 5k. Then, the control by the control portion 5a of the TV 5 is terminated.

According to the first embodiment, as hereinabove described, the control portion 5a of the TV 5 composes the TV cursor 8c so as to overlap the TV image displayed on the display portion 5k on the basis of the converted positional information of the mouse 3 in the video composition portion 5j, whereby the control portion 5a can compose the TV cursor 8c so as to overlap the TV image on the basis of the positional information of the mouse 3 that the user can intuitively operate so that processing to the TV 5 regarding the operation based on the operating information of the mouse 3 may not be performed in the PC 1. Thus, processing in the PC 1 can be inhibited from increase so that a load applied to the PC 1 can be inhibited from increase. Further, operability for the user in operating the TV 5 can be improved. The user can set whether the operating information constituted by the positional information, the left click information, the right click information and the scrolling information of the mouse 3 is transmitted from the USB transmitting and receiving portion 1g through the USB terminal 1e in the PC 1 while the user can set whether the operating information is received by the USB transmitting and receiving portion 5d through the USB terminal 5c in the TV 5, whereby the user can set the operating information not to be transmitted from the PC 1 to the TV 5 when the operating information from the PC 1 to the TV 5 is not necessary. Thus, the unnecessary operating information can be inhibited from being transmitted to the TV 5 so that a load applied to the TV 5 can be inhibited from increase.

According to the first embodiment, as hereinabove described, the positional information prepared on the basis of the screen resolution (800×600) set in the PC 1 is converted to conform to the screen resolution (1920×1080) set in the display portion 5k by the control portion 5a in the scaler 5i, whereby the display processing for composing the TV cursor 8c with the TV image is performed by the control portion 5a on the basis of the positional information of the mouse 3, and the display-processed TV image can be displayed on the display portion 5k of the TV 5.

According to the first embodiment, as hereinabove described, in the scaler 5i, the positional information prepared on the basis of the screen resolution (800×600) set in the PC 1 is converted on the basis of the ratio of length (2.4) and the ratio of width (1.8) to conform to the screen resolution (1920×1080) set in the display portion 5k, whereby information regarding a position of the TV cursor 8c can be easily converted on the basis of the ratio of the screen resolution set in the display portion 5k to the screen resolution set in the PC 1.

According to the first embodiment, as hereinabove described, the driver and the application enable the control portion 1a to allow the USB transmitting and receiving portion 1g to receive the operating information constituted by the positional information, the left click information, the right click information and the scrolling information of the mouse 3 through the USB terminal 1c, enable the user to set whether to transmit the operating information from the USB transmitting and receiving portion 1g through the USB terminal 1e and enable transmission of the operating information from the USB transmitting and receiving portion 1g through the USB terminal 1e when the operating information is set so as to be transmitted from the USB transmitting and receiving portion 1g by the user are transmitted from the TV 5 and received by the USB transmitting and receiving portion 1g when the PC 1 and the TV 5 are connected to each other through the USB cable 2c, whereby the PC 1 can obtain the driver and the application for transmitting the operating information input through the mouse 3 simply by connecting the PC 1 to the TV 5 without another operation by the user. Further, in the PC 1, the user can easily set whether to transmit the operating information and the operating information can be easily transmitted to the TV 5 on the basis of the obtained driver and application. Thus, convenience for the user can be further improved.

According to the first embodiment, as hereinabove described, when the operating information is set so as to be transmitted from the USB transmitting and receiving portion 1g of the PC 1 by the user, the operating information is transmitted (passes through) from the USB transmitting and receiving portion 1g through the USB terminal 1e without analysis by the control portion 1a. Thus, the operating information is not analyzed in the PC 1 when unnecessary in the PC 1 so that a load applied to the PC 1 (control portion 1a) can be inhibited from increase.

According to the first embodiment, as hereinabove described, the PC 1 is provided with the HDMI transmitting and receiving portion 1h for transmitting the image of the PC 1 separately from the USB transmitting and receiving portion 1g while the receiving apparatus is provided with the HDMI transmitting and receiving portion 5h for receiving the image of the PC 1 separately from the USB transmitting and receiving portion 5d. Thus, the operating information and information of the image of the PC 1 can be transmitted and received via different pathways so that the operating information and the image of the PC 1 can be further reliably transmitted and received.

According to the first embodiment, as hereinabove described, the operating information is transmitted from the USB transmitting and receiving portion 1g through the USB terminal 1e without analysis by the control portion 1a when the operating information is set so as to be transmitted in the PC 1 by the user, and the operating is analyzed by the control portion 1a and the processing in the PC 1 is performed when the operating information is set so as not to be transmitted in the PC 1 by the user. Thus, when the operating information is set so as to be transmitted in the PC 1 by the user, the operating information is transmitted to the TV 5 so that the user can operate the TV 5, and when the operating information is set so as not to be transmitted in the PC 1 by the user, the user can operate the application or the like of the PC 1.

According to the first embodiment, as hereinabove described, the messages 8f to 8h about whether to transmit the operating information constituted by the positional information, the left click information, the right click information and the scrolling information of the mouse 3 from the PC 1 to the TV 5 are displayed on the display portion 5k, whereby the user can visually recognize whether to transmit the operating information from the PC 1 to the TV 5. Thus, the user can visually check to be operating the PC 1 or the TV 5 so that an operation different from an operation intended by the user can be inhibited from being performed in the information display system 100.

According to the first embodiment, as hereinabove described, the message 8f that the message 8f that a signal from the mouse 3 is not input is displayed on the display portion 5k by the control portion 5a when the operating information from the mouse 3 is not input to the TV 5. Thus, when the operating information is not transmitted from the PC 1 to the TV 5 due to a disconnection between the mouse 3 and the PC 1 or the like, the user is informed that the operating information is not being received, whereby the user can be prompted to make a connection between the mouse 3 and the PC 1 or the like in order to transmit the operating information from the PC 1 to the TV 5.

According to the first embodiment, as hereinabove described, the control portion 5a of the TV 5 can prioritize the operation of the TV 5 from the remote controller 7 and can prevent acceptance of the operation of the TV 5 from the mouse 3 on the basis of the prescribed operation performed on the remote controller 7 by the user. Thus, when the TV 5 is operated with both the remote controller 7 and the mouse 3 by the user, processing based on the operation of the remote controller 7 by the user is prioritized, whereby an operation different from an operation intended by the user due to an operation of the mouse 3 not intended by the user can be inhibited from being performed in the information display system 100.

### Second Embodiment

A second embodiment is now described with reference to FIGS. 3, 4 and 11 to 14. In an information display system 200 according to this second embodiment, a set top box (STB) 210 and a display 211 are used, and operating information of a mouse 3 is transmitted from a PC 201 to an STB 210 with an analog RGB cable 209 dissimilarly to the aforementioned first embodiment.

The structure of the information display system 200 according to the second embodiment of the present invention is now described with reference to FIGS. 3, 4, 11 and 12.

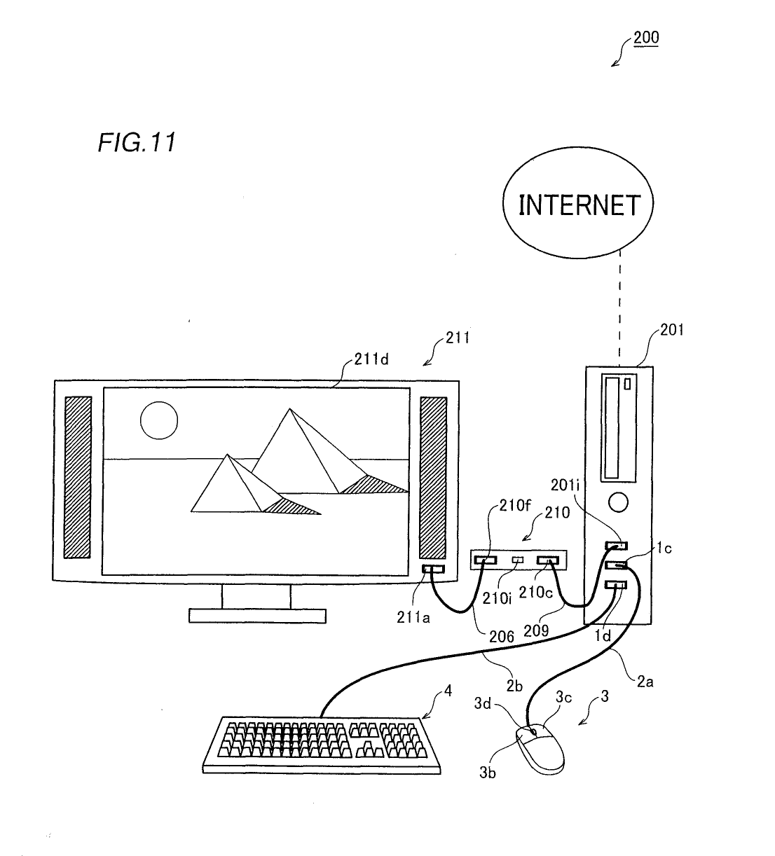

In the information display system 200 according to the second embodiment of the present invention, each of the mouse 3 and a keyboard 4 is connected to the personal computer (PC) 201 as shown in FIG. 11. The set top box (STB) 210 is connected to the PC 201 through the analog RGB cable 209. The STB 210 has a screen resolution of 1920×1080. A display 211 is connected to the STB 210 through an HDMI cable 206. Thus, a PC image and an STB image prepared (composed) in the PC 201 and the STB 210 respectively are transmitted from the STB 210 to the display 211 through the HDMI cable 206. The STB 210 is an example of the “receiving portion” in the present invention.

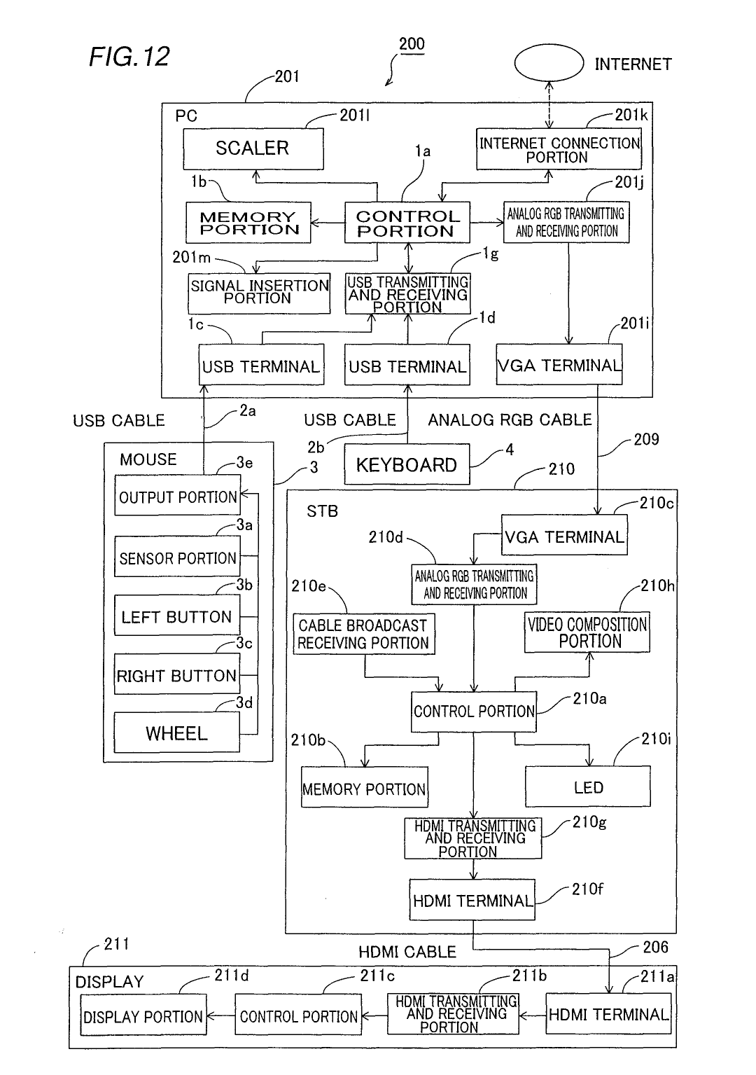

The PC 201 is provided with a VGA terminal 201i as shown in FIG. 12. This VGA terminal 201i is connected to a VGA terminal 210c of the STB 210 described later through the analog RGB cable 209. The VGA terminal 201i is connected to an analog RGB transmitting and receiving portion 201j. An analog RGB signal is transmitted from the analog RGB transmitting and receiving portion 201j to the analog RGB cable 209 through the VGA terminal 201i by a control portion 1a. In the PC 201, an analog RGB signal is received by the analog RGB transmitting and receiving portion 201j from the analog RGB cable 209.

The PC 201 is further provided with an Internet connection portion 201k for connecting to the Internet. A driver and an application are downloaded through the Internet connection portion 201k from the Internet to be stored as programs in a memory portion 1b.

The PC 201 is further provided with a scaler 201l. In this scaler 201l, positional information prepared on the basis of a screen resolution (800×600) set in the PC 201 is converted to conform to the screen resolution (1920×1080) set in the STB 210 by the control portion 1a of the PC 201. The screen resolution (1920×1080) set in the STB 210 is recognized by the control portion 1a by user's inputting of the screen resolution (1920×1080) set in the STB 210 on an input screen displayed on the basis of the driver and the application of the PC 201. The scaler 201l is an example of the “conversion portion” in the present invention.

The PC 201 is further provided with a signal insertion portion 201m. This signal insertion portion 201m can insert the operating information constituted by positional information, left click information, right click information and scrolling information of the mouse 3 into an analog RGB signal on the basis of an instruction of the control portion 1a. Specifically, a portion (VBI (Vertical Blanking Interval)) not including signals regarding a screen exists between analog RGB signals for one screen and analog RGB signals for subsequent one screen. The operating information of the mouse 3 is inserted into this VBI. The analog RGB signals for one screen can be transmitted 60 times a second. Thus, the operating information can be transmitted 60 times a second through the analog RGB cable 209.

According to the second embodiment, the driver and the application stored in the memory portion 1b enable a user to set whether to transmit an analog RGB signal including the operating information of the mouse 3 from the analog RGB transmitting and receiving portion 201j through the VGA terminal 201i in the PC 201. When the analog RGB signal including the operating information is set by the user so as to be transmitted from the analog RGB transmitting and receiving portion 201j, the analog RGB signal including the operating information converted from the positional information is transmitted from the analog RGB transmitting and receiving portion 201j through the VGA terminal 201i on the basis of the driver and the application stored in the memory portion 1b by the control portion 1a of the PC 201.

When the analog RGB signal including the operating information is set by the user so as not to be transmitted from the analog RGB transmitting and receiving portion 201j through the VGA terminal 201i, the operating information is analyzed by the control portion 1a and processing in the PC 201 is performed. The PC image prepared by the processing in the PC 201 is transmitted as an analog RGB signal from the analog RGB transmitting and receiving portion 201j to the STB 210 through the VGA terminal 201i and is transmitted from the STB 210 to the display 211 through the HDMI cable 206.

As shown in FIG. 12, the STB 210 is provided with a control portion 210a, a memory portion 210b constituted by a nonvolatile memory such as a flash memory, in which a program or the like used in the control portion 210a is stored, the VGA terminal 210c, and an analog RGB transmitting and receiving portion 210d connected to the VGA terminal 210c. A signal is transmitted from the analog RGB transmitting and receiving portion 210d to the analog RGB cable 209 through the VGA terminal 210c by the control portion 210a. In the STB 210, the analog RGB transmitting and receiving portion 210d receives a signal from the analog RGB cable 209. The analog RGB transmitting and receiving portion 210d is an example of the “receiving portion” in the present invention.

According to the second embodiment, the user can set whether the analog RGB transmitting and receiving portion 210d receives the operating information constituted by the positional information, the left click information, the right click information and the scrolling information of the mouse 3 through the VGA terminal 210c in the STB 210. When the user sets the analog RGB transmitting and receiving portion 210d to receive the operating information through the VGA terminal 210c, the control portion 210a allows the analog RGB transmitting and receiving portion 210d to receive the operating information through the VGA terminal 210c. When the user sets the analog RGB transmitting and receiving portion 210d not to receive the operating information through the VGA terminal 210c, on the other hand, the control portion 210a does not allow the analog RGB transmitting and receiving portion 210d to receive the operating information through the VGA terminal 210c.

In procedure for specific setting, the user selects that the operating information is not received by the analog RGB transmitting and receiving portion 210d through the VGA terminal 210c in a screen for selecting an operation from a mouse as shown in FIG. 3 in a state where the analog RGB transmitting and receiving portion 210d is receiving the operating information of the mouse 3 through the VGA terminal 210c in the STB 210, whereby processing for switching to an operation of the PC 201 is performed by the control portion 210a. In other words, it switches to processing in which the operating information is not received by the analog RGB transmitting and receiving portion 210d through the VGA terminal 210c by the control portion 210a.

As shown in FIG. 12, the STB 210 is further provided with a cable broadcast receiving portion 210e capable of receiving each of a cable broadcast and an electronic program guide (EPG) regarding the cable broadcast, an HDMI terminal 210f connected with the HDMI cable 206 connected to an HDMI terminal 211a of the display 211 described later, and an HDMI transmitting and receiving portion 210g connected to the HDMI terminal 210f.

The STB 210 is further provided with a video composition portion 210h. In this video composition portion 210h, a TV cursor 8c (see FIG. 4) prepared on the basis of the converted positional information is composed so as to overlap an STB image displayed on a display portion 211d of the display 211 described later by the control portion 210a.

The STB 210 is further provided with an LED 210i capable of lighting in red, orange and green. The control portion 210a makes this LED 210i light in red when the operating information from the mouse 3 is not input to the STB 210. Thus, the user is visually informed that a signal from the mouse 3 is not input by the LED 210i. When the operating information is not received in the STB 210 is input whereas the operating information from the mouse 3 is input to the STB 210, the control portion 210a makes the LED 210i light in orange. Thus, the user is visually informed that the STB 210 is in a mode of not accepting the operation from the mouse 3 by the LED 210i. When the operating information from the mouse 3 is input to the STB 210 and is set so as to be received in the STB 210, the control portion 210a makes the LED 210i light in green. Thus, the user is visually informed that the STB 210 is in a mode of accepting the operation from the mouse 3 by the LED 210i. The LED 210i is an example of the “display means” in the present invention.

As shown in FIG. 12, the display 211 is provided with the HDMI terminal 211a and an HDMI transmitting and receiving portion 211b connected to the HDMI terminal 211a. This HDMI terminal 211a is connected to the HDMI terminal 210f of the STB 210 through the HDMI cable 206. Thus, the PC image and the STB image prepared (composed) in the PC 201 and the STB 210 respectively are received by the display 211 through the HDMI cable 206. The display 211 is not provided on a PC 201 side but an STB 210 side.

The display 211 is further provided with a control portion 211c and the display portion 211d on which the PC image and the STB image prepared (composed) in the PC 201 and the STB 210 respectively are displayed by the control portion 211c.

In the second embodiment, 11 bits as an amount of data for showing a lateral direction (1920) and 11 bits as an amount of data for showing a longitudinal direction (1080) are needed on the basis of the screen resolution (1920×1080) set in the STB 210 in order to transmit the positional information, and it is necessary to transmit two information of having been pushed down and not having been pushed down in order to transmit each of the left click information and the right click information, so that 1 bit is needed for each of the two information and 2 bits in total are needed for each of the left click information and the right click information. It is necessary to transmit three information of upward scrolling information, downward scrolling information and information of not having been operated in order to transmit the scrolling information with the analog RGB cable, so that 2 bits are needed. In other words, at least 26 bits are needed to transmit signals regarding the operating information (positional information, left click information, right click information and scrolling information) of the mouse 3 with the analog RGB cable. The remaining structure of the second embodiment is similar to that of the aforementioned first embodiment.

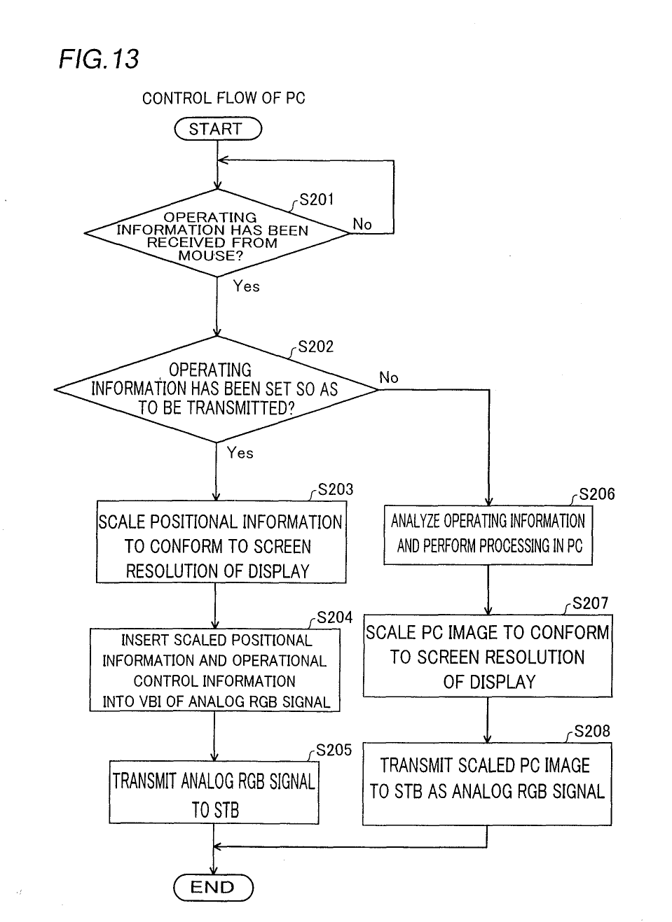

Next, the control flow of the PC 201 of the information display system 200 according to the second embodiment of the present invention is described with reference to FIGS. 12 and 13.

As shown in FIG. 13, the control portion 1a (see FIG. 12) of the PC 201 determines whether the operating information constituted by the positional information, the left click information, the right click information and the scrolling information input by the user through the mouse 3 (see FIG. 12) has been input to the USB transmitting and receiving portion 1g (see FIG. 12) through the USB terminal 1c (see FIG. 12) at a step S201, and the determination at the step S201 is repeated until the operating information has been input to the USB transmitting and receiving portion 1g. When the control portion 1a determines that the operating information has been input to the USB transmitting and receiving portion 1g at the step S201, the process advances to a step S202.

At the step S202, the control portion 1a determines whether the operating information input to the USB transmitting and receiving portion 1g through the mouse 3 has been set so as to be transmitted from the analog RGB transmitting and receiving portion 201j (see FIG. 12) through the VGA terminal 201i (see FIG. 12) on the basis of the driver and the application stored in the memory portion 1b (see FIG. 12). When the control portion 1a determines that the operating information has been set so as to be transmitted at the step S202, the process advances to a step S203. When the control portion 1a determines that the operating information has not been set so as to be transmitted at the step S202, the process advances to a step S206.

At the step S203, the positional information prepared on the basis of the screen resolution (800×600) set in the PC 201 is converted to conform to the screen resolution (1920×1080) set in the STB 210 (see FIG. 12) in the scaler 201l (see FIG. 12) by the control portion 1a. At a step S204, the converted positional information and the operational control information constituted by the left click information, the right click information and the scrolling information are inserted into an analog RGB signal in the signal insertion portion 201m (see FIG. 12). At a step S205, the analog RGB signal including the operating information of the mouse 3 is transmitted from the analog RGB transmitting and receiving portion 201j through the VGA terminal 201i. Then, the control by the control portion 1a of the PC 201 is terminated.

At the step S206, the operating information of the mouse 3 is analyzed by the control portion 1a and the processing is performed in the PC 201. At a step S207, the PC image prepared on the basis of the screen resolution (800×600) set in the PC 201 is converted to conform to the screen resolution (1920×1080) set in the STB 210 in the scaler 201l. At a step S208, the PC image is transmitted as an analog RGB signal from the analog RGB transmitting and receiving portion 201j through the VGA terminal 201i. Then the control by the control portion 1a of the PC 201 is terminated.

Next, the control flow of the STB 210 of the information display system 200 according to the second embodiment of the present invention is described with reference to FIGS. 4, 12 and 14.

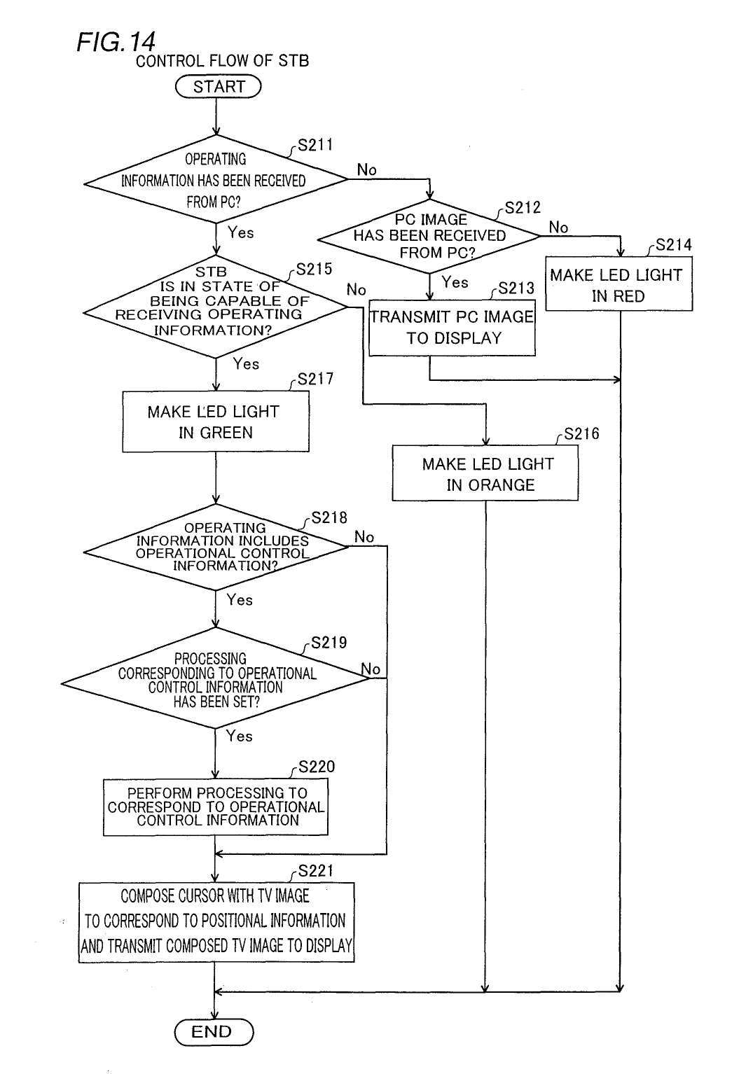

As shown in FIG. 14, the control portion 210a determines whether the analog RGB signal including the operating information constituted by the positional information, the left click information, the right click information and the scrolling information from the mouse 3 (see FIG. 12) has been received by the analog RGB transmitting and receiving portion 210d (see FIG. 12) through the VGA terminal 210c (see FIG. 12) at a step S211. When the control portion 210a determines that the analog RGB signal including the operating information has not been received at the step S211, the process advances to a step S212. When the control portion 210a determines that the analog RGB signal including the operating information has been received at the step S211, the process advances to a step S215.

At the step S212, the control portion 210a determines whether the PC image prepared by the processing in the PC 201 has been received as an analog RGB signal by the analog RGB transmitting and receiving portion 210d through the VGA terminal 210c. When the control portion 210a determines that the PC image has been received as an analog RGB signal at the step S212, the PC image is transmitted from the HDMI transmitting and receiving portion 210g (see FIG. 12) to the display 211 through the HDMI terminal 210f (see FIG. 12) at a step S213. Then, the control by the control portion 210a of the STB 210 is terminated. When the control portion 210a determines that the PC image has not been received as an analog RGB signal at the step S212, the control portion 210a makes the LED 210i (see FIG. 12) light in red at a step S214. Then, the control by the control portion 210a of the STB 210 is terminated.

At the step S215, the control portion 210a determines whether the STB 210 is in a state of being capable of receiving the analog RGB signal including the operating information of the mouse 3. When the control portion 210a determines that the STB 210 is not in a state of being capable of receiving the analog RGB signal including the operating information at the step S215, the control portion 210a makes the LED 210i light in orange at a step S216. Then, the control by the control portion 210a of the STB 210 is terminated. When the control portion 210a determines that the STB 210 is in a state of being capable of receiving the analog RGB signal including the operating information at the step S215, the process advances to a step S217.

At the step S217, the control portion 210a makes the LED 210i light in green. At a step S218, the control portion 210a determines whether the received operating information includes the operational control information constituted by the left click information, the right click information and the scrolling information. When the control portion 210a determines that the received operating information includes the operational control information at the step S218, the process advances to a step S219. When the control portion 210a determines that the received operating information does not include the operational control information at the step S218, the process advances to a step S221.

At the step S219, the control portion 210a determines whether processing corresponding to the received operational control information has been set on a position where the TV cursor 8c (see FIG. 4) is displayed, determined on the basis of the positional information. When the control portion 210a determines that the processing corresponding to the received operational control information has been set on a position where the TV cursor 8c is displayed at the step S219, the process advances to a step S220. When the control portion 210a determines that the processing corresponding to the received operational control information has been not set on a position where the TV cursor 8c is displayed, determined on the basis of the positional information at the step S219, the process advances to a step S221.

At the step S220, the processing set on a position where the TV cursor 8c is displayed is performed by the control portion 210a to correspond to the received operational control information. Finally, at the step S221, the converted positional information is composed so as to overlap the STB image displayed on the display portion 211d (see FIG. 12) as the TV cursor 8c, and the display-processed STB image including the TV cursor 8c is transmitted from the HDMI transmitting and receiving portion 210g to the display 211 through the HDMI terminal 210f. Then, the control by the control portion 210a of the STB 210 is terminated.

According to the second embodiment, as hereinabove described, both the image of the PC 201 and the operating information are transmitted from the analog RGB transmitting and receiving portion 201j in the PC 201 and both the image of the PC 201 and the operating information are received by the analog RGB transmitting and receiving portion 210d in the STB 210, whereby the analog RGB transmitting and receiving portions 201j and 210d for transmitting and receiving the image of the PC 201 and the operating information can be shared. Therefore, the number of components in the information display system 200 can be inhibited from increase. The remaining effects of the second embodiment are similar to those of the aforementioned first embodiment.

Although the present invention has been described and illustrated in detail, it is clearly understood that the same is by way of illustration and example only and is not to be taken by way of limitation, the spirit and scope of the present invention being limited only by the terms of the appended claims.

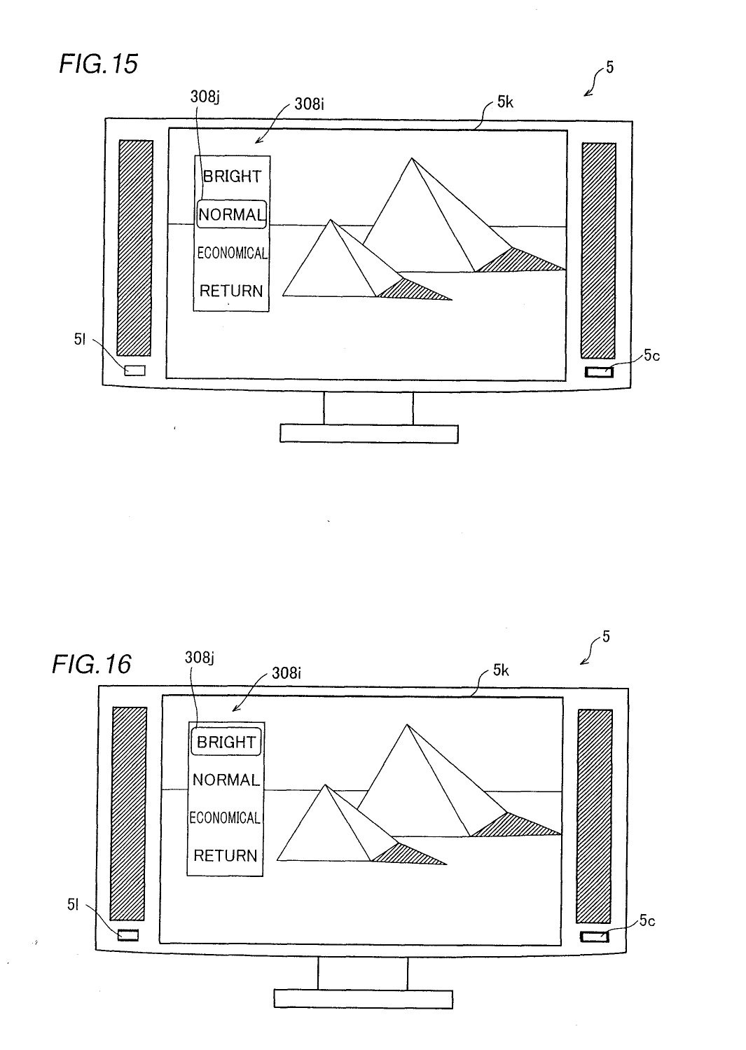

For example, while the arrow-shaped TV cursor 8c is moved on the basis of the positional information of the mouse 3 in each of the aforementioned first and second embodiments, the present invention is not restricted to this. In the present invention, movement of the mouse over a prescribed distance with respect to vertical and horizontal directions may be recognized as movement of a selection cursor capable of moving only on options. Specifically, in a modification of the first and second embodiments, a selection icon 308i is displayed as an OSD on the display portion 5k of the TV 5 while the selection cursor 308j is displayed to be positioned on “NORMAL” of the options of the selection icon 308i, as shown in FIG. 15. The user upwardly moves the mouse 3 (see FIG. 2) by a prescribed distance from this state, whereby the control portion 5a (see FIG. 2) of the TV 5 recognizes that the mouse 3 has upwardly moved by a distance from an option to the next option of the selection icon 308i. Thus, as shown in FIG. 16, the selection cursor 308j may be displayed to be positioned on “BRIGHT” of the options of the selection icon 308i by being displayed on the display portion 5k in a state of having moved upwardly by the distance from an option to the next option. By this structure, the selection cursor 308j can be easily moved on the basis of a prescribed movement amount of the mouse 3. In order to transmit the movement of the mouse 3, 1 bit as an amount of data necessary to show whether the mouse has moved by the prescribed distance is needed for each of vertical and horizontal directions, so that 4 bits in total are needed and are fewer than 10 bits as an amount of data for showing a lateral direction and 10 bits as an amount of data for showing a longitudinal direction necessary to transmit the operating information of the mouse 3 in the first and second embodiments (20 bits in total). Thus, the number of bits in the transmission of a signal regarding the operating information of the mouse 3 can be reduced.

While the driver and the application used in the PC 1 are transmitted from the TV 5 when the PC 1 and the TV 5 are connected to each other through the USB cable 2c, whereby the driver and application are stored in the memory portion 1b by the PC 1 in the aforementioned first embodiment and the driver and the application used in the PC 201 are downloaded through the Internet connection portion 201k from the Internet in the aforementioned second embodiment, whereby the driver and application are stored in the memory portion 1b by the PC 201, the present invention is not restricted to this. In the present invention, the driver and the application used in the PC may be preliminarily stored in the memory portion. Further, the driver and the application may be stored in the memory portion by being installed on the PC from a storage medium such as a DVD, or the like.

While in the aforementioned first embodiment, the icon 8b is selected in a state of not transmitting the operating information constituted by the positional information, the left click information, the right click information and the scrolling information of the mouse 3 from the USB transmitting and receiving portion 1g through the USB terminal 1e whereby the operating information is transmitted from the USB transmitting and receiving portion 1g through the USB terminal 1e, the present invention is not restricted to this. For example, the user may set whether to transmit the operating information of the mouse from the USB transmitting and receiving portion through the USB terminal by providing a switch button on a housing of the PC.

While in the aforementioned first embodiment, the prescribed operation is performed on the remote controller 7 by the user whereby whether the USB transmitting and receiving portion 5d receives the operating information of the mouse 3 through the USB terminal 5c is set, the present invention is not restricted to this. For example, an icon switching to an operation of the PC may be displayed on the display portion and the user may be allowed to select the icon thereby switching to the operation of the PC.

While the mouse 3 is used as the “input device” in the present invention in the each of the aforementioned first and second embodiments, the present invention is not restricted to this. For example, an input device such as a keyboard and a joystick other than the mouse may be used.

While the single mouse 3 is used in the each of the aforementioned first and second embodiments, the present invention is not restricted to this. In the present invention, a plurality of mice may be used. At this time, cursors corresponding to the respective mice may be displayed on the display portion in a state of distinguishing the cursors corresponding to the respective mice from each other by making colors of the cursors corresponding to the respective mice different from each other or putting a sign with respect to each of the cursors corresponding to the mice.

While the TV 5 is set so as to prioritize the operation of the TV 5 from the remote controller 7 and prevent acceptance of the operation of the TV 5 from the mouse 3 on the basis of the prescribed operation performed on the remote controller 7 by the user in the aforementioned first embodiment, the present invention is not restricted to this. In the present invention, the TV 5 may be set so as to prioritize the operation of the TV from the mouse and prevent acceptance of the operation of the TV from the remote controller on the basis of the operation from the remote controller by the user.

While the user is visually informed whether to transmit the operating information constituted by the positional information, the left click information, the right click information and the scrolling information of the mouse 3 from the PC 1 to the TV 5 by displaying the messages 8f to 8h on the display portion 5k in the aforementioned first embodiment and the user is visually informed whether the operating information is transmitted from the PC 201 to the STB 210 by changing the color of the LED 210i in the aforementioned second embodiment, the present invention is not restricted to this. In the present invention, the user may be visually informed whether to transmit the operating information of the mouse by displaying an icon on the display portion or providing a small display portion independently of the display portion on the remote controller or the like to display whether to transmit the operating information on the small display portion. Further, the user may be aurally informed whether to transmit the operating information with sound.

While the operating information of the mouse 3 is transmitted with the USB cable 2c in the aforementioned first embodiment and the analog RGB signal including the operating information of the mouse 3 is transmitted with the analog RGB cable 209 in the aforementioned second embodiment, the present invention is not restricted to this. For example, the operating information of the mouse may be transmitted with an IEEE 1394 cable.

While only the TV 5 is connected to the PC 1 in the aforementioned first embodiment, the present invention is not restricted to this. In the present invention, a display may be connected to the PC, separately from the TV. At this time, the PC image may be displayed on either the display or the TV by allowing a device displaying the PC image to be switched on the basis of the driver and the application stored in the memory portion.

While the operating information of the mouse 3 is transmitted from the USB transmitting and receiving portion 1g to the USB transmitting and receiving portion 5d and the programs of the driver and the application are transmitted from the USB transmitting and receiving portion 5d to the USB transmitting and receiving portion 1g in the aforementioned first embodiment, the present invention is not restricted to this. In the present invention, a transmitting portion from which the operating information of the mouse is transmitted and a receiving portion receiving the programs may be made different from each other, and a transmitting portion from which the programs are transmitted and a receiving portion receiving the operating information of the mouse may be made different from each other.

While the screen resolution set in the PC 1 is recognized by the control portion 5a of the TV 5 when the signal having information of the screen resolution set in the PC 1 transmitted from the PC 1 is received through the HDMI cable 6 in the aforementioned first embodiment and the screen resolution set in the STB 210 is recognized by the control portion 1a of the PC 201 by user's inputting of the screen resolution set in the STB 210 in the aforementioned second embodiment, the present invention is not restricted to this. In the present invention, the screen resolution set in the PC or the TV (STB) may be recognized by the TV (STB) or the PC through the USB cable. At this time, the screen resolution set in the PC can be transmitted from the PC to the TV (STB) and the screen resolution set in the TV (STB) can be read by the PC on the basis of the driver and the application stored in the memory portion of the PC.

While the scaler 201l is provided in the PC 201 and the screen resolution set in the STB 210 is recognized by the control portion 1a of the PC 201 by user's inputting of the screen resolution set in the STB 210 in the aforementioned second embodiment, the present invention is not restricted to this. In the present invention, the screen resolution set in the PC may be recognized by providing the scaler in the STB not the PC and detecting the frequencies of synchronization signals of the analog RGB signal in the control portion of the STB.

While the screen resolution set in the PC 1 is recognized by the control portion 5a of the TV 5 when the scaler 5i is provided in the TV 5 and the signal having information of the screen resolution set in the PC 1 transmitted from the PC 1 is received through the HDMI cable 6 in the aforementioned first embodiment, the present invention is not restricted to this. In the present invention, the screen resolution set in the TV may be recognized in the PC when the scaler is provided in the PC not the TV and the signal having information of the screen resolution set in the TV transmitted from the TV is received through the HDMI cable.

While the screen resolutions set in the PC 1 (201) and the TV 5 (STB 210) are 800×600 and 1920×1080, respectively in each of the aforementioned first and second embodiments, the present invention is not restricted to this. In the present invention, the screen resolutions set in the PC and the TV (STB) are not particularly restricted. Further, the screen resolutions set in the PC and the TV (STB) may be the same as each other. At this time, no scaler for converting the positional information may be provided.

While in the aforementioned first embodiment, the operating information of the mouse 3 is transmitted from the USB transmitting and receiving portion 1g to the TV 5 through the USB cable 2c and a signal is transmitted from the HDMI transmitting and receiving portion 1h to the TV 5 through the HDMI cable 6 in the PC 1 and in the aforementioned second embodiment, the analog RGB signal including the operating information of the mouse 3 is transmitted from the analog RGB transmitting and receiving portion 201j to the STB 210 through the analog RGB cable 209 in the PC 201, the present invention is not restricted to this. In the present invention, the operating information of the mouse may be included in the analog RGB signal to be transmitted to the TV through the analog RGB cable in the PC. Further, the operating information of the mouse may be transmitted to the STB through the USB cable in the PC.

While the mouse 3 is connected to the PC 1 (201) through the USB cable 2a in each of the aforementioned first and second embodiments, the present invention is not restricted to this. In the present invention, connection between the PC and the mouse is not restricted to connection through the USB cable. For example, the PC and the mouse may be connected to each other in PS/2 format, and the operating information may be transmitted from the mouse to the PC by radio without using the cable. A method standardized by the IEEE (The Institute of Electrical and Electronics Engineers, Inc.) can be employed as a method of transmission by radio. For example, the operating information can be transmitted by radio on the basis of a standard such as IEEE 802.15.1 (Bluetooth), IEEE 802.11b, IEEE 802.11a, IEEE 802.11g or IEEE 802.11n. Further, means of radio communication with a radio transceiver module in the PC, means of radio communication with a module for radio communication USB-connected to the PC and so on exist as communication means by radio. The present invention is not restricted to the aforementioned method of transmission by radio, but another method of transmission by radio other than the above may be employed so far as at least the operating information of the mouse can be transmitted. While in the TV 5, the prescribed operation is performed on the remote controller 7 by the user whereby whether the operating information is received by the USB transmitting and receiving portion 5d through the USB terminal 5c is set in the aforementioned first embodiment, the present invention is not restricted to this. In the present invention, a state where the USB transmitting and receiving portion cannot receive the operating information may be automatically switched to a state where the USB transmitting and receiving portion can receive the operating information also in the TV following performance of the processing for switching to an operation of the TV in the PC. At this time, the PC image being displayed on the display portion of the TV may be automatically switched to the TV image.

While the EPG regarding a television broadcast is received from an antenna by the channel selection portion 5e in the aforementioned first embodiment and the EPG regarding a cable broadcast is received by the cable broadcast receiving portion 210e in the aforementioned second embodiment, the present invention is not restricted to this. In the present invention, the EPG may be obtained via the Internet to be transmitted from the PC to the TV (STB) in the PC connected to the Internet.

While the positional information, the left click information, the right click information and the scrolling information of the mouse 3 are employed as the operating information of the mouse 3 in each of the aforementioned first and second embodiments, the present invention is not restricted to this. In the present invention, another information other than the positional information, the left click information, the right click information and the scrolling information may be employed as the operating information of the mouse (input device). For example, buttons other than the left and right buttons are provided on the mouse, and arbitrary operations of the PC and the TV are preliminarily allocated to the buttons. Button push-down information based on push-down operations of the buttons may be employed as the operating information of the mouse.

What is claimed is:

1. An information display system comprising:
an input device to which a user inputs operating information;
a computer connected with said input device, including a transmitting portion for transmitting said operating information input through said input device;
a receiving apparatus including a receiving portion for receiving said operating information transmitted by said computer and a control portion capable of performing display processing of a cursor on the basis of said operating information of said input device; and
a display portion provided on a side of said receiving apparatus, capable of displaying an image and displaying an image on which said display processing for composing said cursor with an image is performed by said control portion of said receiving apparatus on the basis of said operating information of said input device, wherein
the user can set whether to transmit said operating information from said computer to said receiving apparatus in at least either said computer or said receiving apparatus.

2. The information display system according to claim 1, wherein
said input device includes a pointing device,
said operating information includes information regarding a position of said pointing device, and
said control portion of said receiving apparatus is formed to compose said cursor with an image on the basis of the information regarding a position of said pointing device.

3. The information display system according to claim 2, further comprising a conversion portion for converting the information regarding a position of said pointing device so that said cursor can be composed with an image when a screen resolution set in said computer and a screen resolution set in said receiving apparatus are different from each other.

4. The information display system according to claim 3, wherein
said conversion portion converts the information regarding a position of said pointing device on the basis of a ratio of said screen resolution set in said receiving apparatus to said screen resolution set in said computer.

5. The information display system according to claim 1, wherein
said receiving apparatus further includes a first memory portion storing a program for transmitting said operating information input to said computer through said input device and a program transmitting portion transmitting said program to said computer,
said computer further includes a program receiving portion receiving said program from said receiving apparatus and a second memory portion storing received said program,
said receiving apparatus transmits said program to said computer when said receiving apparatus and said computer are connected to each other so that said program is stored in said second memory portion of said computer, and
said computer transmits said operating information input through said input device on the basis of said program stored in said second memory portion.

6. The information display system according to claim 5, wherein
the user sets whether to transmit said operating information from said computer to said receiving apparatus, and said computer further transmits said operating information to said receiving apparatus when the user sets said computer to transmit said operating information on the basis of said program.

7. The information display system according to claim 1, wherein
said computer transmits said operating information to said receiving apparatus without analyzing said operating information when the user sets said computer to transmit said operating information.

8. The information display system according to claim 1, wherein
said computer further includes an image transmitting portion for transmitting an image of said computer to said receiving apparatus independently of said transmitting portion, and
said receiving apparatus further includes an image receiving portion for receiving the image of said computer from said image transmitting portion independently of said receiving portion.

9. The information display system according to claim 8, wherein
said computer transmits said operating information to said receiving portion of said receiving apparatus through said transmitting portion when the user sets said computer to transmit said operating information, and said computer analyzes said operating information and prepares the image of said computer to transmit the image of said computer to said image receiving portion of said receiving apparatus through said image transmitting portion when the user sets said computer not to transmit said operating information.

10. The information display system according to claim 1, wherein
said computer transmits both the image of said computer and said operating information through said transmitting portion, and
said receiving portion of said receiving apparatus receives both the image of said computer and said operating information.

11. The information display system according to claim 1, further comprising display means for visually informing the user whether to transmit said operating information from said computer to said receiving apparatus.

12. The information display system according to claim 11, wherein
said display means displays a notice that said operating information has not been received on said display portion when the user sets said receiving apparatus to transmit said operating information and said operating information is not transmitted from said computer to said receiving apparatus.

13. The information display system according to claim 1, further comprising a remote controller for allowing the user to operate said receiving apparatus, wherein
said control portion of said receiving apparatus is formed to be capable of prioritizing processing based on an operation of said remote controller by the user over processing based on said operating information of said input device.

14. The information display system according to claim 1, wherein
said operating information includes information regarding a movement amount of said input device,
said display portion displays an image on which display processing is performed by said control portion of said receiving apparatus such that said cursor moves between a plurality of selection icons, and
said control portion of said receiving apparatus performs said display processing such that said cursor moves between the plurality of selection icons every prescribed said movement amount.

15. An information display apparatus, comprising:
a receiving apparatus including a receiving portion for receiving operating information of an input device transmitted by a computer connected with said input device to which a user inputs said operating information and a control portion capable of performing display processing of a cursor on the basis of said operating information of said input device; and
a display portion capable of displaying an image and displaying an image on which said display processing for composing said cursor with an image is performed by said control portion of said receiving apparatus on the basis of said operating information of said input device, wherein
the user can set whether to transmit said operating information from said computer to said receiving apparatus.

16. The information display apparatus according to claim 15, wherein
said receiving apparatus includes a television apparatus or a set top box.

17. The information display apparatus according to claim 15, wherein
said input device includes a pointing device, and said operating information includes information regarding a position of said pointing device, and
said control portion of said receiving apparatus is formed to compose said cursor with an image on the basis of the information regarding a position of said pointing device.

18. The information display apparatus according to claim 17, further comprising a conversion portion for converting the information regarding a position of said pointing device so that said cursor can be composed with an image when a screen resolution set in said computer and a screen resolution set in said receiving apparatus are different from each other.

19. The information display apparatus according to claim 15, further comprising display means for visually informing the user whether to transmit said operating information from said computer to said receiving apparatus.

20. The information display apparatus according to claim 15, further comprising a remote controller for allowing the user to operate said receiving apparatus, wherein
said control portion of said receiving apparatus is formed to be capable of prioritizing processing based on an operation of said remote controller by the user over processing based on said operating information of said input device.
